(19) United States
(12) Patent Application Publication
(10) Pub. No.: US 2025/0330909 A1
(43) Pub. Date: Oct. 23, 2025

(54) OPERATION OF A USER EQUIPMENT INCLUDING MULTIPLE RADIOS

(71) Applicant: QUALCOMM Incorporated, San Diego, CA (US)

(72) Inventors: Ahmed ELSHAFIE, San Diego, CA (US); Zhikun WU, Beijing (CN); Seyedkianoush HOSSEINI, San Diego, CA (US); Yuchul KIM, San Diego, CA (US); Linhai HE, San Diego, CA (US); Huilin XU, Temecula, CA (US); Cong NGUYEN, San Diego, CA (US)

(21) Appl. No.: 18/863,512

(22) PCT Filed: Jul. 8, 2022
(86) PCT No.: PCT/CN2022/104543

§ 371 Date: Nov. 6, 2024

(51) Int. Cl. H04W 52/02; H04W 48/18; H04W 88/06

(52) U.S. Cl. CPC H04W 52/0235; H04W 48/18; H04W 88/06

(57) ABSTRACT

The described aspects may improve the operation and performance of a user equipment (UE) implementing multiple radios. In an aspect, an apparatus for wireless communication including a first radio and a second radio is provided. The apparatus may be a UE. The apparatus powers OFF the first radio when the second radio is to be used for one or more wireless communications. The first radio enables communication using resources associated with a mobile network and the second radio enables communication with a passive communication device. The apparatus communicates using the second radio while the first radio is powered OFF.

### BACKGROUND

### Technical Field

The present disclosure relates generally to communication systems, and more particularly, to the operation of a user equipment (UE) including multiple radios.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user equipment (UE) as described herein may implement multiple radios to allow the UE to communicate with a mobile network and a passive communication device (e.g., an RFID tag). Implementation of such multiple radios overcomes the difficult and costly alternative of incorporating a non-orthogonal frequency-division multiplexing (non-OFDM) transceiver in an orthogonal frequency-division multiplexing (OFDM) transceiver typically included in a UE.

For example, the UE may implement a first radio (also referred to as a main radio), such as a radio capable of Wi-Fi, NR, and/or LTE protocol communications and a second radio (also referred to as a secondary radio), such as a Passive Internet of things (PIoT) radio. In some examples, a PIoT radio may be an RFID radio or a radio capable of communicating with RFID devices (e.g., an RFID tag). The second radio may allow the UE to comply with PIoT communication specifications and may facilitate decoding of continuous wave (CW) signals, where CW signals typically have higher energy than backscattered signals. The aspects described herein may improve the operation and performance of a UE implementing multiple radios.

In an aspect of the disclosure, a method, a computer-readable medium, and an apparatus are provided. The apparatus may be a user equipment (UE). The UE powers OFF a first radio when a second radio is to be used for one or more wireless communications, wherein the first radio enables communication using resources associated with a mobile network and the second radio enables communication with a passive communication device. The UE communicates using the second radio while the first radio is powered OFF.

In an aspect of the disclosure, a method, a computer-readable medium, and an apparatus are provided. The apparatus may be a UE. The UE operates a first radio based on a first discontinuous reception mode configuration, wherein the first radio enables communication using resources associated with a mobile network. The UE operates a second radio based on a second discontinuous reception mode configuration, wherein the second radio enables communication with a passive communication device.

In an aspect of the disclosure, a method, a computer-readable medium, and an apparatus are provided. The apparatus may be a network node (e.g., a base station). The network node determines configuration information for a UE that includes a first radio and a second radio, wherein the first radio enables communication using resources associated with a mobile network and the second radio enables communication with a passive communication device, and wherein the configuration information includes at least a first discontinuous reception mode configuration for the first radio and a second discontinuous reception mode configuration for the second radio. The network node transmits the configuration information using the resources associated with the mobile network.

In an aspect of the disclosure, a method, a computer-readable medium, and an apparatus are provided. The apparatus includes a first radio for communication using resources associated with a mobile network; a second radio for communication with a passive communication device; a memory; and at least one processor coupled to the memory. The apparatus receives information indicating a first discontinuous reception (DRX) cycle of a third radio of a user equipment (UE) and a second DRX cycle of a fourth radio of the UE, wherein the third radio enables communication using the resources associated with the mobile network, and wherein the fourth radio enables communication with the passive communication device. The apparatus transmits at least one of a first signal during an active time of the first DRX cycle using the first radio or a second signal during an active time of the second DRX cycle using the second radio.

In some aspects, the apparatus transmits, using the first radio, configuration information associated with the fourth radio.

In some aspects, the configuration information includes at least one of a set of frequencies to be supported by the fourth radio, one or more time-frequency allocations, or a first set of configuration settings that enables a signal reception at the fourth radio.

In some aspects, the apparatus transmits a wakeup signal associated with the fourth radio before the active time of the second DRX cycle.

In some aspects, the apparatus transmits a wakeup signal associated with the third radio before the active time of the first DRX cycle.

In some aspects, the apparatus transmits a wakeup signal associated with the third radio and fourth radio before the active time of the first DRX cycle and the active time of the second DRX cycle.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 shows a diagram illustrating an example disaggregated base station architecture.

FIG. 5 is a diagram of a UE including an OFDM receiver circuit.

FIG. 6 is a diagram of a radio frequency identification (RFID) signal decoder circuit.

FIG. 7 is a diagram including a first UE, a second UE, and a passive communication device.

FIGS. 8A, 8B, and 8C are diagrams illustrating example waveforms of the signals described with reference to FIG. 7.

FIG. 9 is a diagram of a UE in accordance with various aspects of the disclosure.

FIG. 10 is a diagram of a UE in accordance with various aspects of the disclosure.

FIGS. 11A, 11B, 11C illustrate examples of different discontinuous reception (DRX) mode configurations.

FIG. 12 is a signal flow diagram in accordance with various aspects of the disclosure.

FIGS. 13A and 13B are a signal flow diagram in accordance with various aspects of the disclosure.

FIG. 14 illustrates a first UE in communication with a second UE.

FIG. 15 is a flowchart of a method of wireless communication.

FIG. 16 is a flowchart of a method of wireless communication.

FIGS. 17A and 17B are a flowchart of a method of wireless communication.

FIGS. 18A and 18B are a flowchart of a method of wireless communication.

FIG. 19 is a conceptual data flow diagram illustrating the data flow between different means/components in an example apparatus.

FIG. 20 is a diagram illustrating an example of a hardware implementation for an apparatus employing a processing system.

FIG. 21 is a flowchart of a method of wireless communication.

FIG. 22 is a flowchart of a method of wireless communication.

FIG. 23 is a conceptual data flow diagram illustrating the data flow between different means/components in an example apparatus.

FIG. 24 is a diagram illustrating an example of a hardware implementation for an apparatus employing a processing system.

FIG. 25 is a flowchart of a method of wireless communication.

FIG. 26 is a flowchart of a method of wireless communication.

FIG. 27 is a conceptual data flow diagram illustrating the data flow between different means/components in an example apparatus.

FIG. 28 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

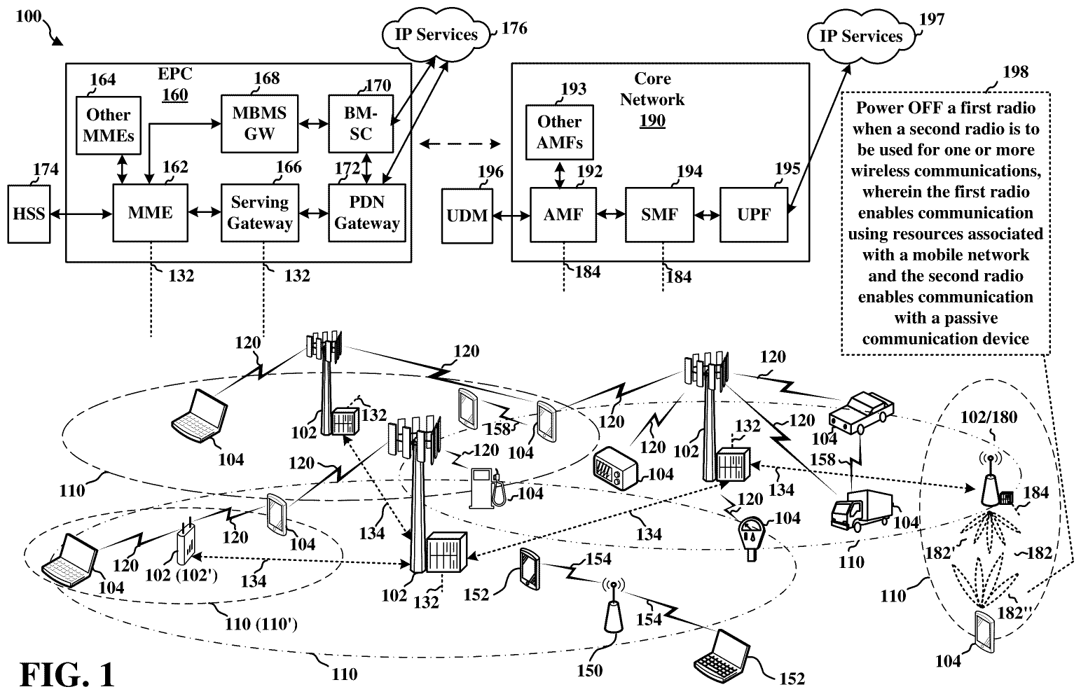

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to power OFF a first radio when a second radio is to be used for one or more wireless communications, wherein the first radio enables communication using resources associated with a mobile network and the second radio enables communication with a passive communication device. Although the following description may be focused on 5G NR, the concepts described herein may be applicable to other similar areas, such as LTE, LTE-A, CDMA, GSM, and other wireless technologies.

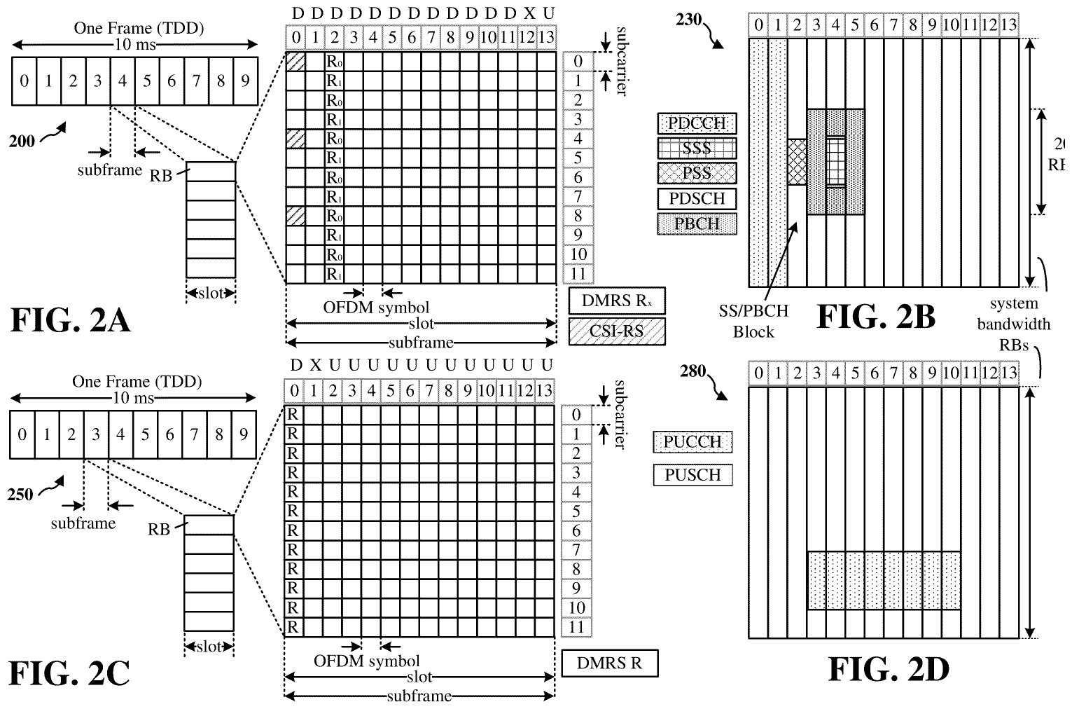

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

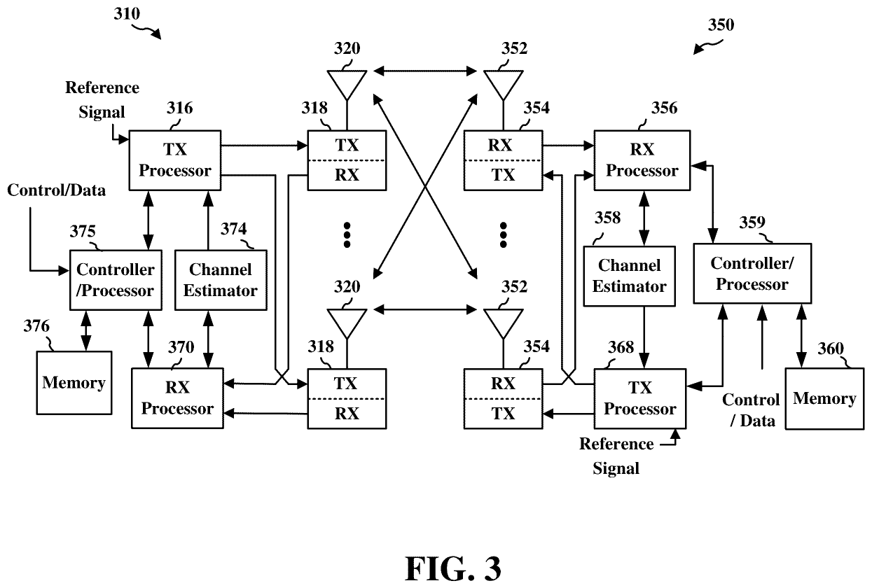

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

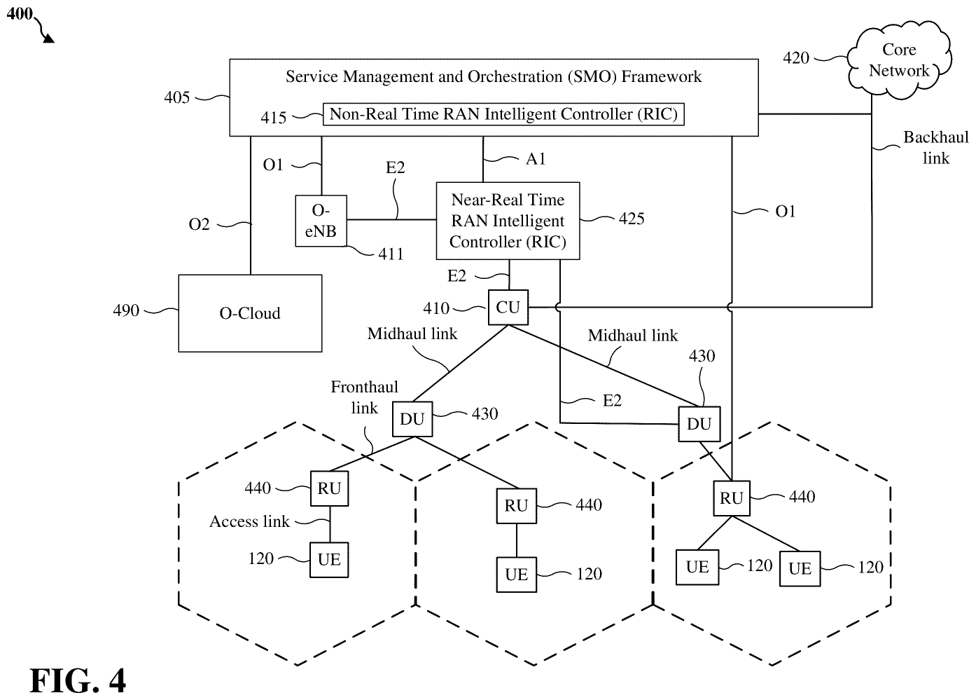

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 120 via one or more radio frequency (RF) access links. In some implementations, the UE 120 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 120. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

Energy harvesting technology has been attracting interest in the context of UEs having reduced capability (e.g., RedCap devices) and Passive Internet of things (PIoT) devices. Devices powered by energy harvesting may opportunistically harvest energy from sources available in their environment, such as solar, heat ambient RF radiation, etc., and may store the energy in a rechargeable battery.

Protocol enhancements to support operation using intermittently available energy harvested from the environment are becoming increasingly valuable. Such protocol enhancements may consider variations in the amounts of harvested energy at UEs and the network traffic of the UEs. However, a device operating on intermittently available energy harvested from the environment may not sustain long continuous reception/transmission. It should be noted that devices powered by energy harvesting may not be limited to the RedCap use case and solutions should also be applicable to non-RedCap use cases.

Some types of energy harvesting devices may be capable of PIoT communications based on backscatter communications. Such energy harvesting devices may not include a power supply (e.g., a battery) and may collect energy from ambient RF signals and may redirect the collected energy (e.g., similar to the operation of a radio frequency identification (RFID) tag). It should be noted, however, that other types of energy harvesting powered devices may need to operate power consuming radio frequency (RF) components, such as analog-to-digital converters (ADCs), mixers, and oscillators.

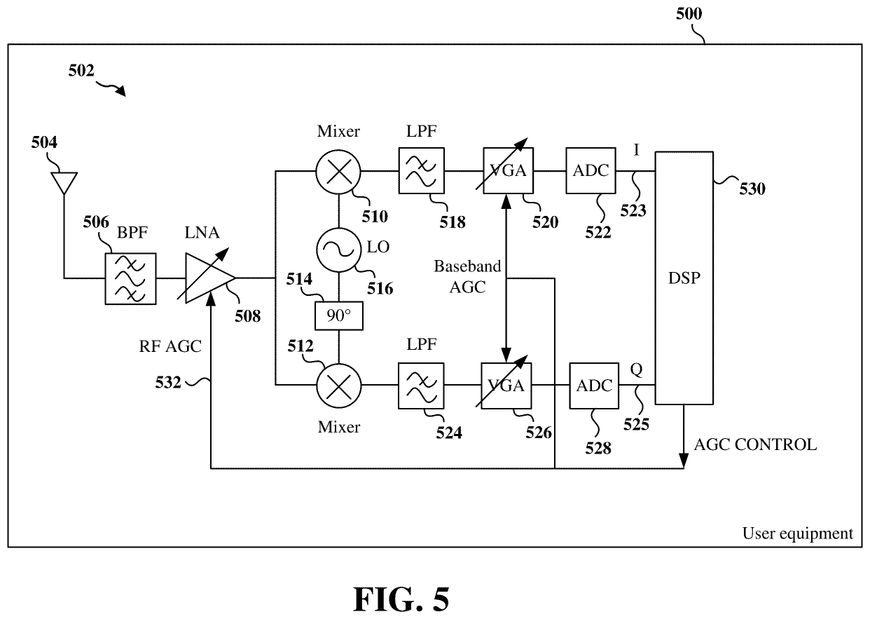

FIG. 5 is a diagram of a UE 500 including an OFDM receiver circuit 502. The OFDM receiver circuit 502 includes an antenna 504, a band-pass filter (BPF) 506, a low noise amplifier (LNA) 508, mixers 510, 512, a local oscillator (LO) 516, a 90° phase shifter 514, low-pass filters (LPFs) 518, 524, variable gain amplifiers (VGAs) 520, 526, ADCs 522, 528, and a digital signal processor 530.

The antenna 504 may receive a signal transmission, which may include a useful signal, interference, and noise. The mixers 510, 512, LPFs 518, 524, VGAs 520, 526, and ADCs 522, 528 may provide OFDM baseband signals at ADC outputs 523, 525. For example, the ADC outputs 523, 525 may represent the in-phase (I) and quadrature phase (Q) channels of the OFDM baseband signals.

At 532, a cyclic prefix (CP) of a first OFDM symbol may be used for automatic gain control (AGC) training. The LNA 508 may avoid or reduce introduction of noise to an amplified signal at the output of the LNA 508.

For example, the dynamic range of the DSP 530 may be 50 decibels (dB). Therefore, a signal from the antenna 504 (e.g., useful signals+interference+noise) having a signal strength of [A, A+50] dB, may be successfully decoded without distortion. The value of A may be reconfigurable.

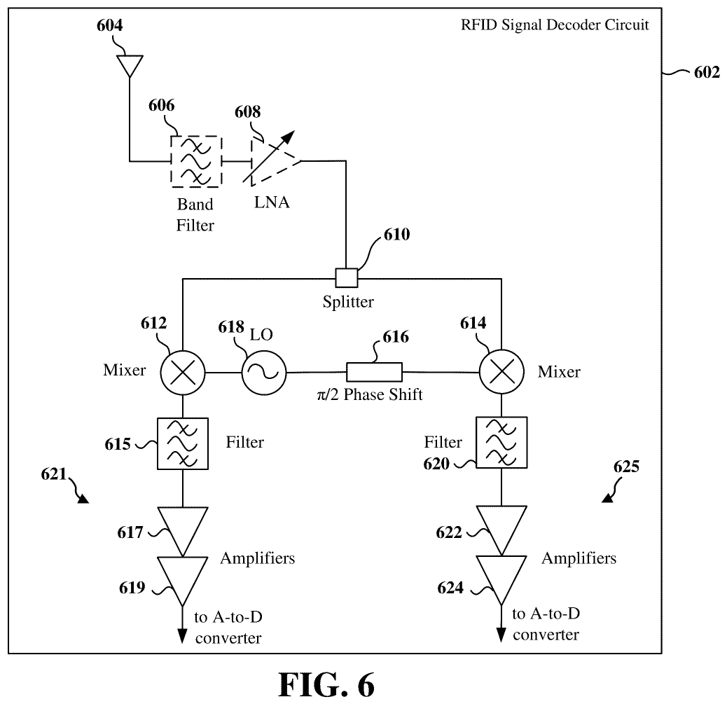

FIG. 6 is a diagram of a RFID signal decoder circuit 602. The RFID signal decoder circuit 602 includes an antenna 604, a band filter 606, an LNA 608, a power splitter 610, mixers 612, 614, an LO 618, a 90° phase shifter 616, LPFs 615, 620, and amplifiers 617, 619, 622, 624. In some implementations, the band filter 606 and the LNA 608 may be optionally omitted.

The antenna 604 may receive a signal transmission (e.g., a backscattered signal from an RFID tag), which may include a useful signal, interference, and noise. The mixers 612, 614, LPFs 615, 620, and amplifiers 617, 619, 622, 624 may provide in-phase (I) and quadrature phase (Q) channels (e.g., at respective branches 621, 625) of the baseband signals. As indicated in FIG. 6, the I and Q channels at respective branches 621, 625 may be provided to respective ADCs.

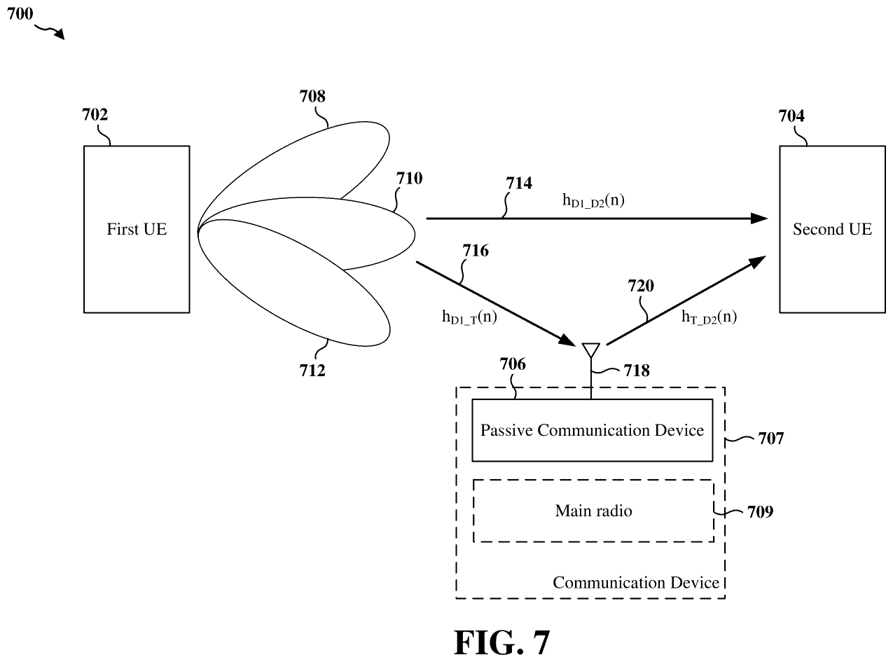

FIG. 7 is a diagram 700 including a first UE 702, a second UE 704, and a passive communication device 706. In some examples, the passive communication device 706 may be an RFID tag (e.g., a standalone RFID tag). In some aspects, the passive communication device 706 may be included in a communication device 707.

For example, the communication device 707 may be a UE including a main radio 709. The main radio 709 may enable communication using resources of a mobile network (e.g., a 5G network, an LTE network, etc.) or other type of network (e.g., a local area network (LAN), such as a Wi-Fi network). In some aspects, if the communication device 707 is a UE, the passive communication device 706 may serve as a second radio (e.g., relative to the main radio 709) of the UE. In these aspects, the UE may use the passive communication device 706 to communicate during low power state conditions of the UE, or based on scheduling from a network node (e.g., a base station) or a controlling unit.

The first UE 702 may transmit a continuous wave (CW) signal using one or more beams (e.g., beams 708, 710, 712). In FIG. 7, a CW signal transmitted from the first UE 702 may include the signal h_{D1_D2}(n) 714 received at the second UE 704 and the signal h_{D1_T}(n) 716 received at the passive communication device 706.

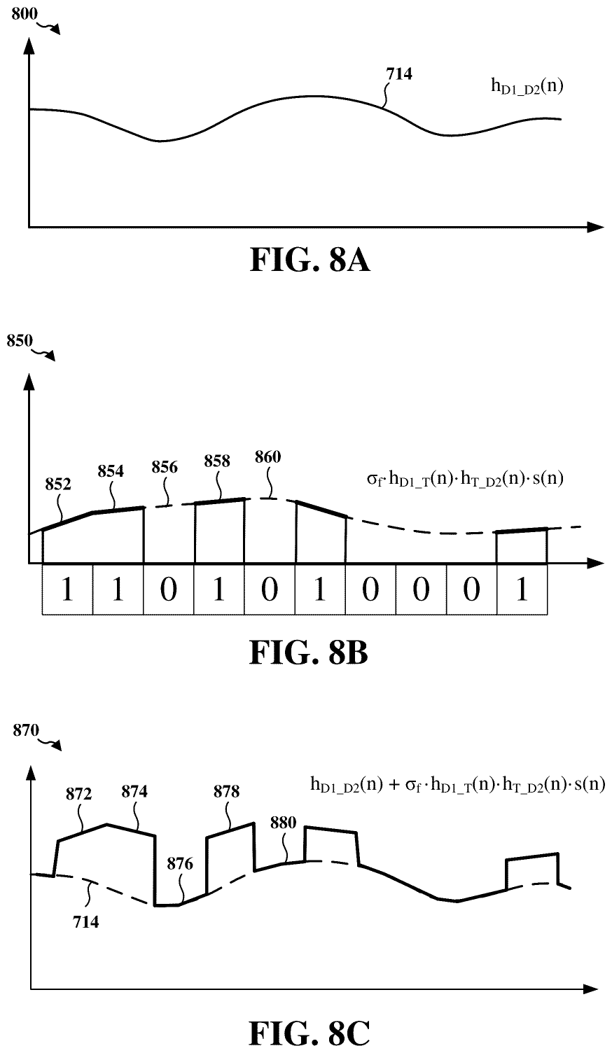

The passive communication device 706 may receive the signal h_{D1_T}(n) 716 (e.g., via an antenna 718) and may backscatter a signal h_{T_D2}(n) 720. The passive communication device 706 may apply a modulation scheme to the signal h_{T_D2}(n) 720, such as amplitude shift keying (ASK). Amplitude shift keying in this context involves switching ON a signal reflection when transmitting information bit ‘1’ and switching OFF the signal reflection when transmitting information bit ‘0’. This is illustrated in FIG. 8B.

In one example, if the first UE 702 transmits a CW signal denoted as x(n), the information bits transmitted from the passive communication device 706 may be expressed as s(n)∈{0,1}. Therefore, the signal h_{T_D2}(n) 720 received at the second UE 704 may carry information bits based on the expression σ_{f}·h_{D1_T}(n)·h_{T_D2}(n)·s(n).

FIGS. 8A, 8B, and 8C are diagrams 800, 850, 870 illustrating example waveforms of the signals described with reference to FIG. 7. For example, FIG. 8A illustrates an example waveform of the signal h_{D1_D2}(n) 714. In some examples, the signal h_{D1_D2}(n) 714 may be a CW signal.

FIG. 8B illustrates an example waveform of the signal h_{D1_D2}(n) 714 after application of the amplitude shift keying modulation scheme. For example, in FIG. 8B, it should be noted that each of the solid portions of the waveform (e.g., portions 852, 854, 858) during a sampling period represents information bit ‘1’ (e.g., by switching ON the reflection of the signal h_{D1_T}(n) 716), and each of the dashed portions of the waveform (e.g., portions 856, 860) during a sampling period represents information bit ‘0’ (e.g., by switching OFF the reflection of the signal h_{D1_T}(n) 716). It should be noted that the waveform in FIG. 8B may be expressed as σ_{f}·h_{D1_T}(n)·h_{T_D2}(n)·s(n).

FIG. 8C illustrates an example waveform representing a sum of the signal h_{D1_D2}(n) 714, the signal h_{T_D2}(n) 720 (which may carry information bits based on the expression σ_{f}·h_{D1_T}(n)·h_{T_D2}(n)·s(n)), and noise. Therefore, the waveform in FIG. 8C may be expressed as y(n)=[h_{D1_D2}(n)+σ_{f}·h_{D1_T}(n)·h_{T_D2}(n) s(n)]·x(n)+noise. For example, in FIG. 8C, it should be noted that each of the solid portions of the waveform (e.g., portions 872, 874, 878) above the dashed line (e.g., the signal h_{D1_D2}(n) 714) represent information bit ‘1’, and each of the solid portions of the waveform (e.g., portions 876, 880) along the dashed line (e.g., the signal h_{D1_D2}(n) 714) represent information bit ‘0’.

In the aspects described herein, a UE may implement two radios. For example, a UE may implement a first radio (also referred to as a main radio), such as a radio capable of Wi-Fi, NR, and/or LTE protocol communications (e.g., in NR and LTE, this may be achieved using the Uu and PC5 interfaces) and a second radio (also referred to as a secondary radio), such as a Passive Internet of things (PIoT) radio. In some examples, a PIoT radio may be an RFID radio or a radio capable of communicating with RFID devices (e.g., an RFID tag). The first and second radios may each be capable of signal reception (Rx) and signal transmission (Tx).

The Uu interface is implemented between a network node (e.g., a base station, such as a gNB or a device that includes a gNB modem) and a UE (or a device that has a UE modem communicating via a Uu link). The PC5 interface (also referred to as a sidelink) is implemented between two UEs having PC5 interfaces.

The second radio may allow the UE to comply with PIoT communication specifications and may facilitate decoding of continuous wave (CW) signals, where CW signals are typically higher than backscattered signals. Furthermore, the second radio may facilitate implementation of a modulated CW signal for sending commands (e.g., a write command) to an RFID tag or other PIoT device. Since implementation of a non-OFDM transceiver in an OFDM transceiver that is typically included in a UE may be difficult and costly, implementation of the previously described second radio may overcome such difficulties while allowing UEs to communicate with PIoT devices.

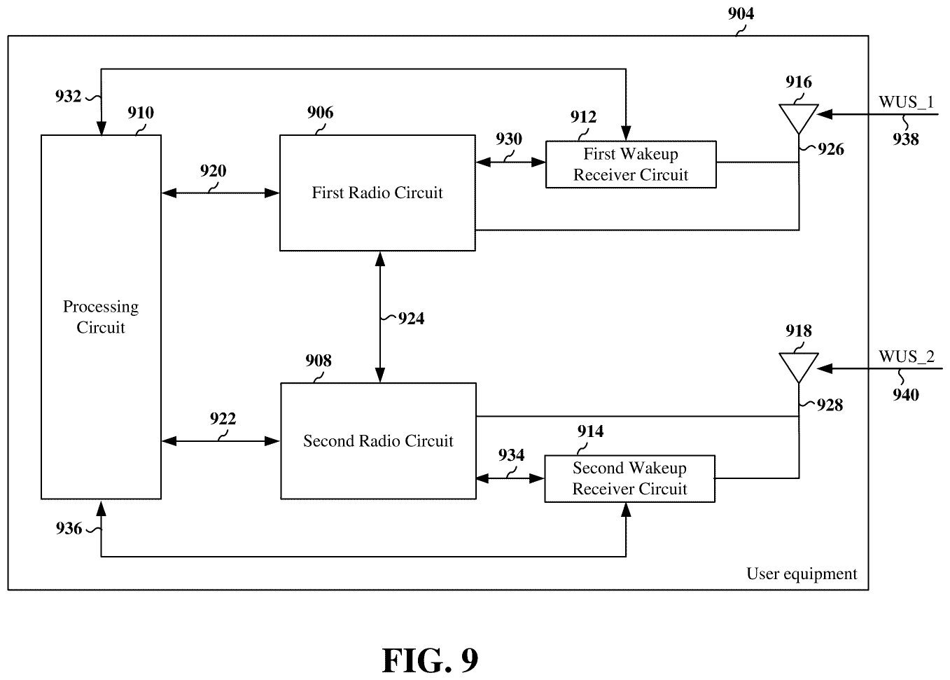

FIG. 9 is a diagram of a UE 904 in accordance with various aspects of the disclosure. The UE 904 includes a first radio circuit 906, a second radio circuit 908, a processing circuit 910, a first wakeup receiver circuit 912, a second wakeup receiver circuit 914, a first antenna 916, and a second antenna 918. In some aspects, the first radio circuit 906 may enable wireless communication using resources of a mobile network (e.g., a 5G NR network, an LTE network, etc.) or other type of network (e.g., a local area network (LAN), such as a Wi-Fi network). The second radio circuit 908 may enable wireless communication with a passive device (also referred to as a passive communication device). For example, the passive device may be an RFID tag. The first and second wakeup receiver circuits 912, 914 may be a low power wakeup receiver circuits.

The first antenna 916 is coupled to the first radio circuit 906 and the first wakeup receiver circuit 912. The first wakeup receiver circuit 912 may communicate with the first radio circuit 906 via the data path 930. The second antenna 918 is coupled to the second radio circuit 908 and the second wakeup receiver circuit 914. The second wakeup receiver circuit 914 may communicate with the second radio circuit 908 via the data path 934.

The first radio circuit 906 may communicate with the second radio circuit 908 via the data path 924. In some examples, the first radio circuit 906 can control the second radio circuit 908 by transmitting commands (e.g., control information) via the data path 924. The processing circuit 910 may communicate with the first radio circuit 906 and the second radio circuit 908 via respective data paths 920, 922. The processing circuit 910 may communicate with the first wakeup receiver circuit 912 and the second wakeup receiver circuit 914 via respective data paths 932, 936.

In one example, the first radio circuit 906 may be operating in a discontinuous reception (DRX) mode based on a first DRX mode configuration. If the UE 904 receives a first wakeup signal (WUS_1) 938 at the first antenna 916 prior to an active time of a DRX cycle of the first radio circuit 906, the first wakeup receiver circuit 912 may provide the first wakeup signal 938 to the first radio circuit 906 via the data path 930. The first wakeup signal 938 may allow the first radio circuit 906 to wake up (e.g., transition to an awake mode) during the active time of the DRX cycle of the first radio circuit 906.

In another example, if the UE 904 receives the first wakeup signal 938 at the first antenna 916 prior to an active time of a DRX cycle of the first radio circuit 906, the first wakeup receiver circuit 912 may provide the first wakeup signal 938 to the processing circuit 910 via the data path 932. The processing circuit 910 may provide the first wakeup signal 938 to the first radio circuit 906 via the data path 920. The first radio circuit 906 may wake up (e.g., transition to an awake mode) in response to the first wakeup signal 938 during the active time of the DRX cycle of the first radio circuit 906.

In one example, the second radio circuit 908 may be operating in the DRX mode based on a second DRX mode configuration. If the UE 904 receives a second wakeup signal (WUS_2) 940 at the second antenna 918 prior to an active time of a DRX cycle of the second radio circuit 908, the second wakeup receiver circuit 914 may provide the second wakeup signal 940 to the second radio circuit 908 via the data path 934. The second wakeup signal 940 may allow the second radio circuit 908 to wakeup (e.g., transition to an awake mode) during the active time of the DRX cycle of the second radio circuit 908.

In another example, if the UE 904 receives the second wakeup signal 940 at the second antenna 918 prior to an active time of a DRX cycle of the second radio circuit 908, the second wakeup receiver circuit 914 may provide the second wakeup signal 940 to the processing circuit 910 via the data path 936. The processing circuit 910 may provide the second wakeup signal 940 to the second radio circuit 908 via the data path 922. The second radio circuit 908 may wake up (e.g., transition to an awake mode) in response to the second wakeup signal 940 during the active time of the DRX cycle of the second radio circuit 908.

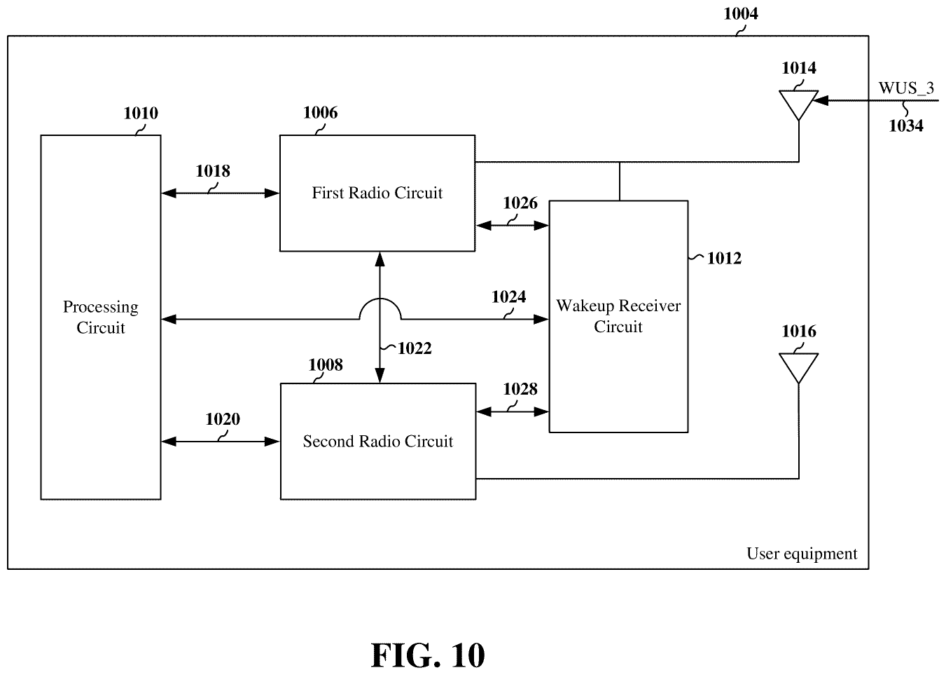

FIG. 10 is a diagram of a UE 1004 in accordance with various aspects of the disclosure. The UE 1004 includes a first radio circuit 1006, a second radio circuit 1008, a processing circuit 1010, a wakeup receiver circuit 1012, a first antenna 1014, and a second antenna 1016. In some aspects, the first radio circuit 1006 may enable wireless communication using resources of a mobile network (e.g., a 5G NR network, an LTE network, etc.) or other type of network (e.g., a LAN, such as a Wi-Fi network). The second radio circuit 1008 may enable wireless communication with a passive device (e.g., an RFID tag). The wakeup receiver circuit 1012 may be a low power wakeup receiver circuit.

The first antenna 1014 is coupled to the first radio circuit 1006 and the wakeup receiver circuit 1012. The second antenna 1016 is coupled to the second radio circuit 1008. The wakeup receiver circuit 1012 may communicate with the processing circuit 1010 via the data path 1024, the first radio circuit 1006 via the data path 1026, and the second radio circuit 1008 via the data path 1028.

The first radio circuit 1006 may communicate with the second radio circuit 1008 via the data path 1022. In some examples, the first radio circuit 1006 can control the second radio circuit 1008 by transmitting commands (e.g., control information) via the data path 1022. The processing circuit 1010 may communicate with the first radio circuit 1006 and the second radio circuit 1008 via respective data paths 1018, 1020.

In one example, the first radio circuit 1006 may be operating in a DRX mode based on a first DRX mode configuration and the second radio circuit 1008 may be operating in the DRX mode based on a second DRX mode configuration. The UE 1004 may receive a wakeup signal (WUS_3) 1034 at the first antenna 1014. The wakeup signal 1034 may be configured to wake up (e.g., transition to an awake mode) the first radio circuit 1006, the second radio circuit 1008, or both the first and second radio circuits 1006, 1008.

In some aspects, the wakeup signal 1034 may include a wakeup indication that can be used to wake up the first radio circuit 1006, the second radio circuit 1008, or both the first and second radio circuits 1006 and 1008. In one example, the wakeup indication may be a two-bit value. The wakeup receiver circuit 1012 may be configured to wake up the first radio circuit 1006 when the wakeup indication in the wakeup signal 1034 is set to a first value (e.g., ‘00’), wake up the second radio circuit 1008 when the wakeup indication in the wakeup signal 1034 is set to a second value (e.g., ‘01’), or wake up both the first and second radio circuits 1006, 1008 when the wakeup indication in the wakeup signal 1034 is set to a third value (e.g., ‘10’).

For example, the first radio circuit 1006 may be operating in a DRX mode based on a first DRX mode configuration. If the UE 1004 receives the wakeup signal 1034 at the antenna 1014 prior to an active time of a DRX cycle of the first radio circuit 1006 and the wakeup indication in the wakeup signal 1034 is set to the first value (e.g., ‘00’), the wakeup receiver circuit 1012 may provide the wakeup signal 1034 to the first radio circuit 1006 via the data path 1026. The wakeup signal 1034 may allow the first radio circuit 1006 to wake up (e.g., transition to an awake mode) during the active time of the DRX cycle of the first radio circuit 1006.

For example, the second radio circuit 1008 may be operating in the DRX mode based on a second DRX mode configuration. If the UE 1004 receives the wakeup signal 1034 at the antenna 1014 prior to an active time of a DRX cycle of the second radio circuit 1008 and the wakeup indication in the wakeup signal 1034 is set to the second value (e.g., ‘01’), the wakeup receiver circuit 1012 may provide the wakeup signal 1034 to the second radio circuit 1008 via the data path 1028. The wakeup signal 1034 may allow the second radio circuit 1008 to wake up (e.g., transition to an awake mode) during the active time of the DRX cycle of the second radio circuit 1008.

For example, the first radio circuit 1006 may be operating in the DRX mode based on a first DRX mode configuration and the second radio circuit 1008 may be operating in the DRX mode based on a second DRX mode configuration. If the UE 1004 receives the wakeup signal 1034 at the antenna 1014 prior to an active time of a DRX cycle of the first radio circuit 1006 and an active time of a DRX cycle of the second radio circuit 1008, and the wakeup indication in the wakeup signal 1034 is set to the third value (e.g., ‘10’), the wakeup receiver circuit 1012 may provide the wakeup signal 1034 to the first and second radio circuits 1006, 1008 via the respective data paths 1026, 1028. The wakeup signal 1034 may allow the first radio circuit 1006 to wake up (e.g., transition to an awake mode) during the active time of the DRX cycle of the first radio circuit 1006 and may allow the second radio circuit 1008 to wake up (e.g., transition to an awake mode) during the active time of the DRX cycle of the second radio circuit 1008.

In some aspects, the wakeup receiver circuit 1012 may be configured to provide the wakeup signal 1034 to the processing circuit 1010 via the data path 1024. The processing circuit 1010 may determine whether the wakeup indication in the wakeup signal 1034 is set to the first value, the second value, or the third value and may transition the first radio circuit 1006 and/or the second radio circuit 1008 to an awake mode based on the value of the wakeup indication.

For example, the processing circuit 1010 may transition the first radio circuit 1006 to the awake mode by transmitting a control signal to the first radio circuit 1006 via the data path 1018. For example, the processing circuit 1010 may transition the second radio circuit 1008 to the awake mode by transmitting a control signal to the second radio circuit 1008 via the data path 1020.

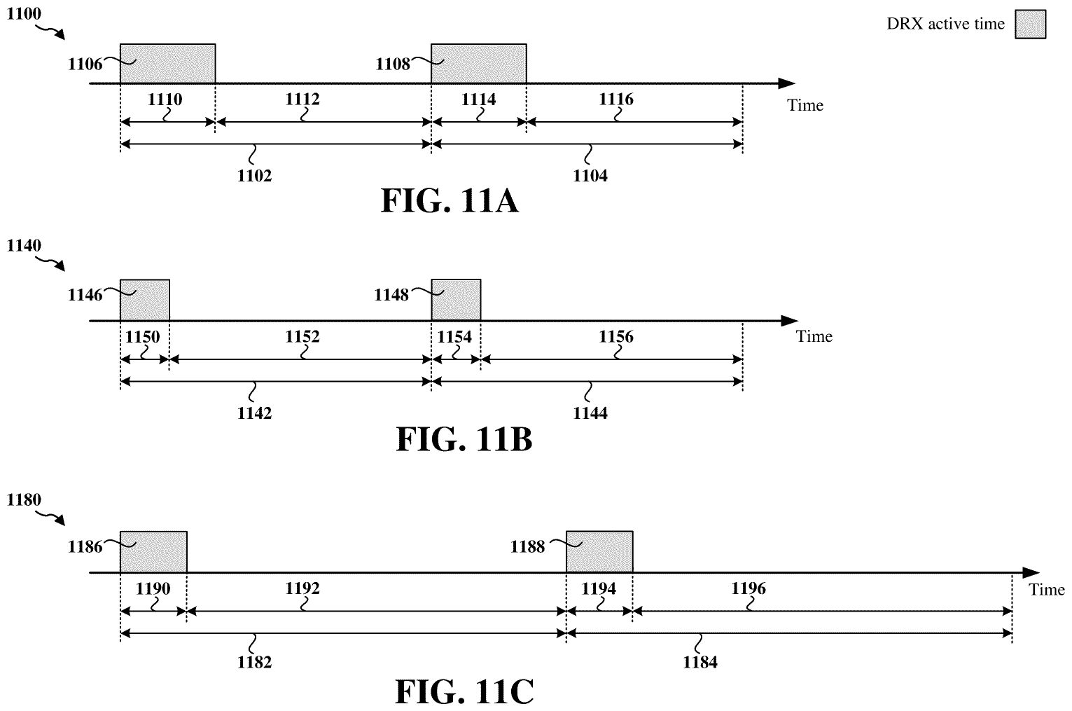

In some aspects, the first radio circuit 1006 and the second radio circuit 1008 may be operating in the DRX mode based on the same DRX mode configuration (e.g., the DRX mode configurations of the first and second radio circuit 1006, 1008 may be the first DRX mode configuration 1100 illustrated in FIG. 11A). Therefore, a DRX active time of the first radio circuit 1006 (e.g., the DRX active time 1108) may be overlapping with a DRX active time of the second radio circuit 1008 (e.g., the DRX active time 1108). In some examples, the wakeup receiver circuit 1012 may monitor for a single wakeup signal (e.g., during a DRX cycle or paging cycle) that applies to both the first and second radio circuits 1006, 1008.

For example, the previously described single wakeup signal may have a single wakeup signal configuration including an RNTI, a search space, etc. common to both the first and second radio circuits 1006, 1008. In some examples, the single wakeup signal may include the previously described wakeup indication (e.g., a two-bit value) which may indicate the radio circuit to be awakened (e.g., the wakeup indication may be used to wake up the first radio circuit 1006, the second radio circuit 1008, or both the first and second radio circuits 1006 and 1008). In some examples, the single wakeup signal may include a timing for waking up one or both of the first and second radio circuits 1006, 1008. In some examples, the single wakeup signal may include any information needed for operation of one or both of the first and second radio circuits 1006, 1008

In other examples, when the first radio circuit 1006 and the second radio circuit 1008 are operating in the DRX mode based on the same DRX mode configuration, the wakeup receiver circuit 1012 may monitor for separate wakeup signals (e.g., during DRX cycles or paging cycles common to both the first and second radio circuits 1006, 1008), where each wakeup signal is associated with a certain radio circuit (e.g., the first radio circuit 1006 or the second radio circuit 1008). For example, each of the separate wakeup signals may be based on a different RNTI, a different scrambling ID, and/or a different search space, or any combination thereof. Each of the separate wakeup signals may include information to wake up one of the radio circuits of the UE 1004 and may include any information needed for operation of that radio circuit.

In another example, the first radio circuit 1006 may be operating based on a first DRX mode configuration and the second radio circuit 1008 may be operating based on a second DRX mode configuration, where the first and second DRX mode configurations are different (e.g., the first DRX mode configuration may be the first DRX mode configuration 1100 illustrated in FIG. 11A and the second DRX mode configuration may be the third DRX mode configuration 1180 illustrated in FIG. 11C). Therefore, a DRX active time of the first radio circuit 1006 (e.g., the DRX active time 1108) may be non-overlapping with a DRX active time of the second radio circuit 1008 (e.g., the DRX active time 1188). In this example, the wakeup receiver circuit 1012 may monitor for separate wakeup signals (e.g., during different DRX cycles or paging cycles of the first and second radio circuits 1006, 1008), where each wakeup signal is associated with a certain radio circuit (e.g., the first radio circuit 1006 or the second radio circuit 1008). For example, each of the separate wakeup signals may include information to wake up one of the radio circuits of the UE 1004 and may include any information needed for operation of that radio circuit.

FIGS. 11A, 11B, 11C illustrate examples of different DRX mode configurations for a UE. For example, FIG. 11A illustrates a first DRX mode configuration 1100 including first and second DRX cycle durations 1102, 1104. The first DRX cycle duration 1102 includes a first DRX active time 1106 and the second DRX cycle duration 1104 includes a second DRX active time 1108. In the aspects described herein, a DRX active time in a DRX cycle may also be referred to as an active time, an ON time, or an active time of the DRX mode.

In FIG. 11A, the first and second DRX cycle durations 1102, 1104 may be the same, and the durations 1110, 1114 of the first and second DRX active times 1106, 1108 may be the same. The durations 1112, 1116 outside of the first and second DRX active times 1106, 1108 may represent OFF cycles in the first and second DRX cycle durations 1102, 1104. In some examples, a UE may power OFF a radio circuit (or a portion of the radio circuit) of the UE during an OFF cycle to reduce power consumption. For example, the UE 904 may power OFF the first radio circuit 906 or the second radio circuit 908 during the durations 1112, 1116.

For example, FIG. 11B illustrates a second DRX mode configuration 1140 including first and second DRX cycle durations 1142, 1144. The first DRX cycle duration 1142 includes a first DRX active time 1146 and the second DRX cycle duration 1144 includes a second DRX active time 1148. The first and second DRX cycle durations 1142, 1144 may be the same. The durations 1150, 1154 of the first and second DRX active times 1146, 1148 may be the same. The durations 1152, 1156 outside of the first and second DRX active times 1146, 1148 may represent OFF cycles in the first and second DRX cycle durations 1142, 1144.

For example, FIG. 11C illustrates a third DRX mode configuration 1180 including first and second DRX cycle durations 1182, 1184. The first DRX cycle duration 1182 includes a first DRX active time 1186 and the second DRX cycle duration 1184 includes a second DRX active time 1188. The first and second DRX cycle durations 1182, 1184 may be the same. The durations 1190, 1194 of the first and second DRX active times 1186, 1188 may be the same. The durations 1192, 1196 outside of the first and second DRX active times 1186, 1188 may represent OFF cycles in the first and second DRX cycle durations 1182, 1184.

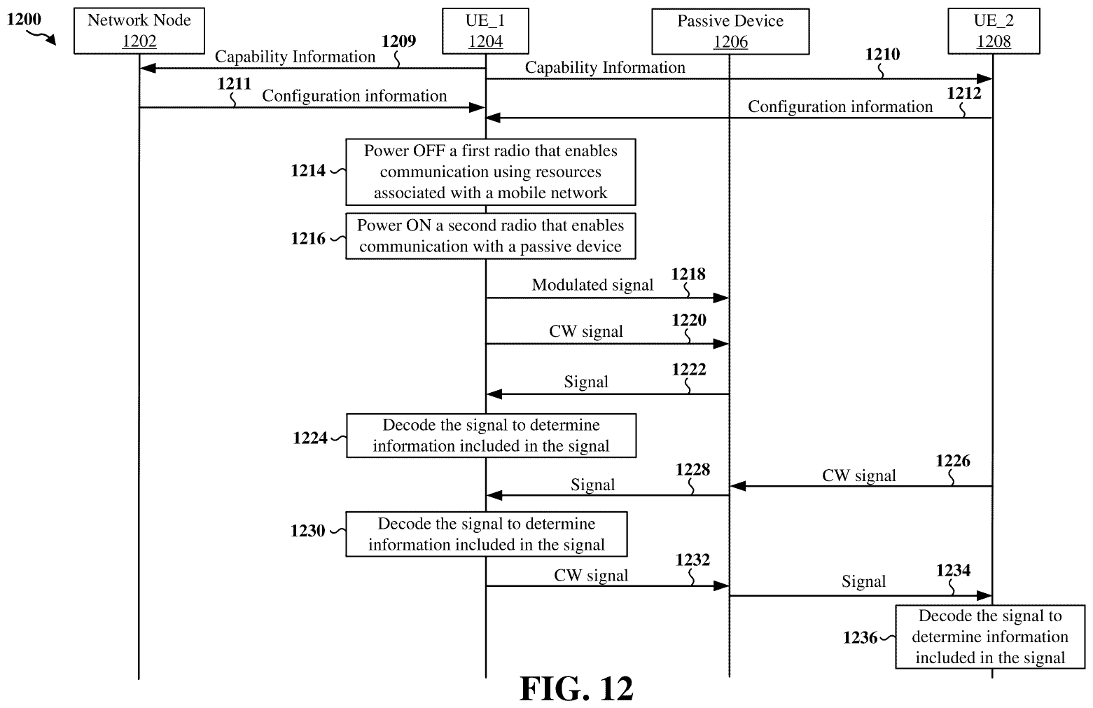

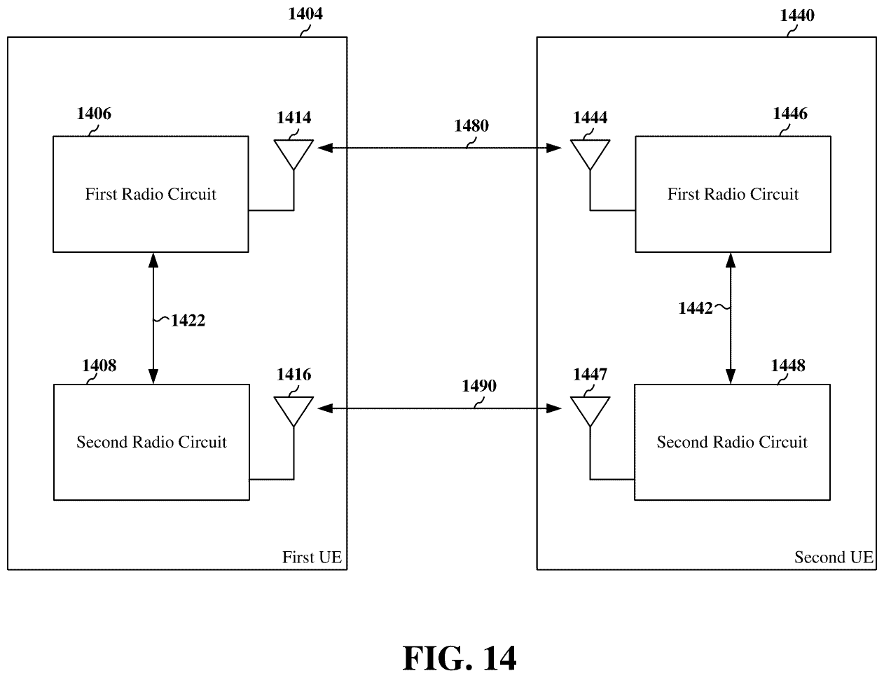

FIG. 12 is a signal flow diagram 1200 in accordance with various aspects of the disclosure. The signal flow diagram 1200 includes a network node 1202, a first UE (UE_1) 1204, a passive device 1206 (also referred to as a passive communication device), and a second UE (UE_2) 1208. In some examples, the first UE 1204 may be the previously described UE 904 or UE 1004. In some examples, the passive device 1206 may be a PIoT device, such an RFID tag). In some examples, the second UE 1208 may be the second UE 1440 described herein with reference to FIG. 14.

In some aspects of the disclosure, the first UE 1204 may transmit capability information 1209, 1210 to report one or more capabilities of the first UE 1204. In some aspects, the first UE 1204 may transmit the capability information 1209 in a UE capability information message (also referred to as a UECapabilityInformation message) in response to UE capability enquiry message (also referred to as a UECapabilityEnquiry message) from the network node 1202.

The capability information 1209, 1210 may indicate that the first UE 1204 supports multiple radios. For example, the capability information 1209, 1210 may indicate that the first UE 1204 includes the first radio circuit 906, 1006 for wireless communications using resources associated with a mobile network (e.g., a 5G NR network, LTE network, etc.) and the second radio circuit 908, 1008 for wireless communications with a passive device (e.g., an RFID tag).

In some aspects, a capability of the first UE 1204 indicated in the capability information 1209, 1210 may be based on certain parameters and their associated values. For example, a capability of the first UE 1204 indicated in the capability information 1209, 1210 may be for a certain band, bandwidth part (BWP), component carrier (CC), and/or frequency range. In some aspects, a capability of the first UE 1204 indicated in the capability information 1209, 1210 may be for any combination of a band, a BWP, a CC, and/or frequency range. For example, the capability information 1209, 1210 may indicate that the first radio circuit 906, 1006 supports communications using a first band, a first BWP, a first CC, and/or a first frequency range and that the second radio circuit 908, 1008 supports communications using a second band, a second BWP, a second CC, and/or a second frequency range.

In some examples, the first UE 1204 may transmit the capability information 1209 during an initial access procedure, such as random access channel (RACH) procedure. For example, the capability information 1209 may be included in a first message (Msg1) or a third message (Msg3) of 4-step RACH procedure, or in a first message (MsgA) of 2-step RACH procedure. In some examples, the capability information 1209 may be included in user assistance information (e.g., in an RRC message). In some examples, the first UE 1204 may indicate the capability information 1209 to the network node 1202 using layer 1, layer 2, or layer 3 signaling.

In some aspects of the disclosure, the certain parameters in the capability information 1209, 1210 may be associated with a certain UE class (also referred to as a UE type). In one example, the first UE 1204 may indicate (e.g., in the capability information 1209) that the first UE 1204 belongs to a class that supports multiple radios. For example, the first UE 1204 may indicate its class (or type) in the capability information 1209 and the network node 1202 may determine the certain parameters (e.g., a band, BWP, CC, and/or frequency range) associated with the first UE 1204 based on the indicated class (or type).

The first UE 1204 may receive configuration information 1211, 1212 associated with the second radio (e.g., the second radio circuit 908, 1008) of the first UE 1204. For example, the first UE 1204 may use its first radio (e.g., the first radio circuit 906, 1006) to receive the configuration information 1211 associated with the second radio (e.g., the second radio circuit 908, 1008) of the first UE 1204 from the network node 1202. In some aspects, the first radio (e.g., the first radio circuit 906, 1006) of the first UE 1204 may provide the configuration information 1211 to the second radio (e.g., the second radio circuit 908, 1008) of the first UE 1204 and/or may control the second radio (e.g., the second radio circuit 908, 1008) based on the configuration information 1211.

In some examples, the configuration information 1211 associated with the second radio (e.g., the second radio circuit 908, 1008) of the first UE 1204 includes configuration information for a DRX mode for the second radio of the first UE 1204, control information, a set of frequencies to be supported by the second radio of the first UE 1204, one or more time-frequency allocations, a first set of configuration settings that enables a signal reception at the second radio, and/or a second set of configuration settings that enables a signal transmission from the second radio.

For example, the first UE 1204 may use its first radio (e.g., the first radio circuit 906, 1006) to receive the configuration information 1212 associated with its second radio (e.g., the second radio circuit 908, 1008) from the second UE 1208. In some examples, the configuration information 1212 associated with the second radio of the first UE 1204 includes at least a set of frequencies to be supported by the second radio of the first UE 1204. For example, the first UE 1204 may use all or a portion of the set of frequencies to communicate with the second UE 1208 using the second radio.

At 1214, the first UE 1204 may power OFF its first radio (e.g., the first radio circuit 906, 1006) that enables communication using resources associated with a mobile network. In some aspects, the first UE 1204 may power OFF its first radio (e.g., the first radio circuit 906, 1006) when its second radio (e.g., the second radio circuit 908, 1008) is to be used for one or more wireless communications. For example, the first UE 1204 may power OFF its first radio when its second radio is to be used to transmit to or receive from the passive device 1206 and/or the second UE 1208.

At 1216, the first UE 1204 may power ON its second radio (e.g., the second radio circuit 908, 1008) that enables communication with the passive device 1206. The first UE 1204 may communicate (e.g., transmit to or receive from the passive device 1206) using the second radio (e.g., the second radio circuit 908, 1008) while the first radio (e.g., the first radio circuit 906, 1006) is powered OFF.

In one example, the passive device 1206 may be a radio frequency identification (RFID) tag. In this example, the first UE 1204 may transmit a modulated signal 1218 using its second radio (e.g., the second radio circuit 908, 1008) to the passive device 1206. The frequency of the modulated signal 1218 may be one of a set of frequencies preconfigured at the first UE 1204 for the second radio. In some examples, the modulated signal 1218 includes one or more commands for the passive device 1206 and any information associated with the one or more commands. For example, the modulated signal 1218 may include a write command and information (e.g., data) to be stored in a memory of the passive device 1206 (e.g., the RFID tag). The passive device 1206 may receive and store the information in the modulated signal 1218.

The first UE 1204 may transmit a continuous wave (CW) signal 1220 (also referred to as an incident CW signal) using its second radio (e.g., the second radio circuit 908, 1008). The first UE 1204 may transmit the CW signal 1220 using a frequency included in the set of frequencies preconfigured at the first UE 1204 for the second radio. The passive device 1206 may receive the CW signal 1220 and may backscatter a signal 1222 in response to the CW signal 1220.

The first UE 1204 may receive the signal 1222 using its second radio e.g., the second radio circuit 908, 1008). For example, the frequency of the signal 1222 may be one of the set of frequencies preconfigured at the first UE 1204 (e.g., based on the configuration information 1212) for the second radio.

At 1224, the first UE 1204 may decode the signal 1222 to determine information included in the signal 1222. In some examples, the signal 1222 may include at least a portion of the previously described information (e.g., data) included in the modulated signal 1218.

In some aspects, the first UE 1204 may receive and decode a backscattered signal from the passive device 1206 (e.g., an RFID tag), where the passive device 1206 backscatters the signal in response to a CW signal from the second UE 1208. For example, with reference to FIG. 12, the second UE 1208 may transmit a CW signal 1226. The passive device 1206 (e.g., an RFID tag) may backscatter a signal 1228 in response to the CW signal 1226.

At 1230, the first UE 1204 may decode the signal 1228 to determine information included in the signal 1228. In some examples, the signal 1228 may include at least a portion of the previously described information (e.g., data) included in the modulated signal 1218.

In some aspects, the second UE 1208 may receive and decode a backscattered signal from the passive device 1206 (e.g., an RFID tag), where the passive device 1206 backscatters the signal in response to a CW signal from the first UE 1204. For example, with reference to FIG. 12, the first UE 1204 may transmit a CW signal 1232. The passive device 1206 (e.g., an RFID tag) may backscatter a signal 1234 in response to the CW signal 1232.

At 1236, the second UE 1208 may decode the signal 1234 to determine information included in the signal 1234. In some examples, the signal 1234 may include at least a portion of the previously described information (e.g., data) included in the modulated signal 1218.

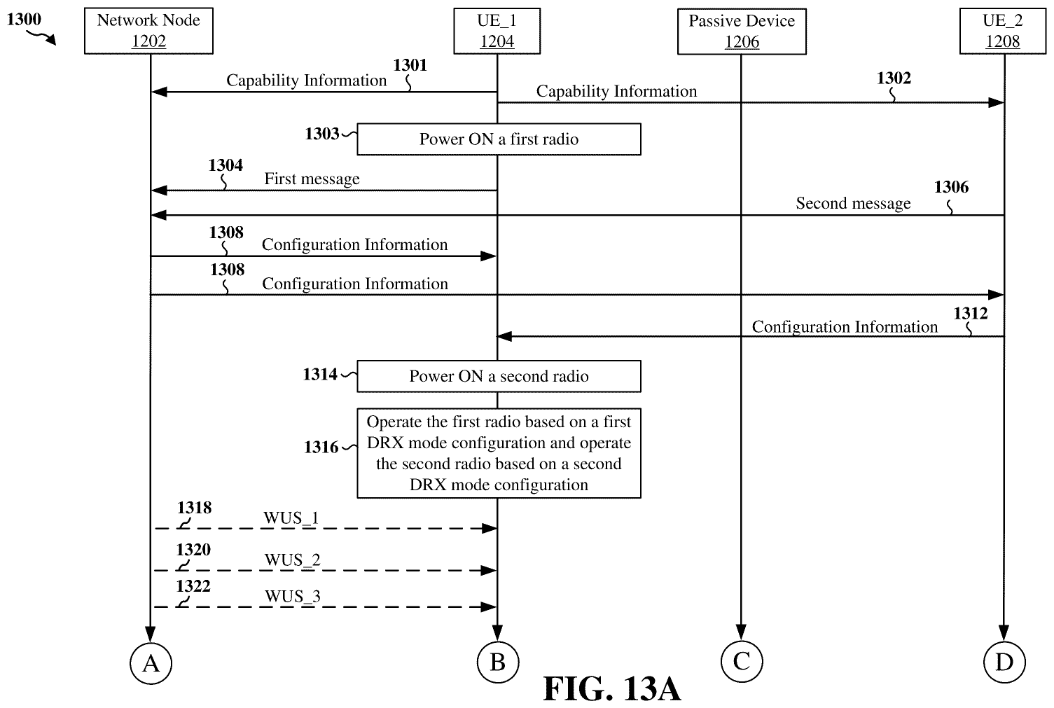

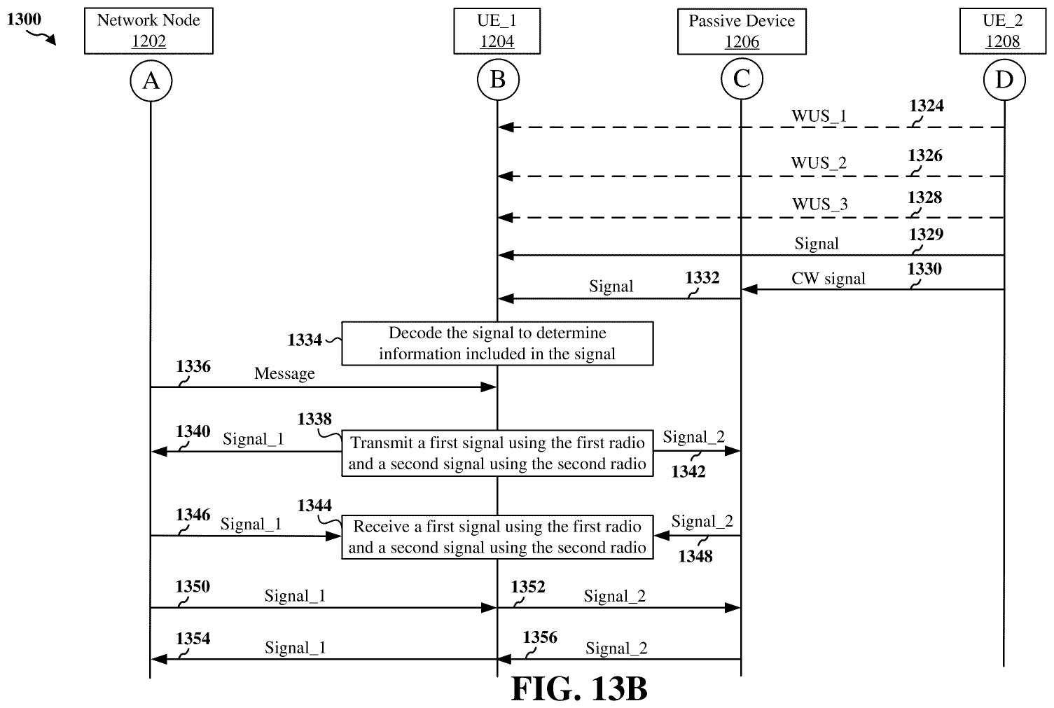

FIGS. 13A and 13B are a signal flow diagram 1200 in accordance with various aspects of the disclosure. The signal flow diagram 1200 includes the network node 1202, the first UE (UE_1) 1204, the passive device 1206, and the second UE (UE_2) 1208.

In some aspects of the disclosure, the first UE 1204 may transmit capability information 1301, 1302 to report one or more capabilities of the first UE 1204. In some aspects, the first UE 1204 may transmit the capability information 1301 in a UE capability information message (also referred to as a UECapabilityInformation message) in response to UE capability enquiry message (also referred to as a UECapabilityEnquiry message) from the network node 1202.

The capability information 1301, 1302 may indicate that the first UE 1204 supports multiple radios. For example, the capability information 1301, 1302 may indicate that the first UE 1204 includes the first radio circuit 906, 1006 for wireless communications using resources associated with a mobile network (e.g., a 5G NR network, LTE network, etc.) and the second radio circuit 908, 1008 for wireless communications with a passive device (e.g., an RFID tag). In some examples, the capability information 1301 in FIG. 13A may include the same information as the capability information 1209 described with reference to FIG. 12 and may be transmitted in a same manner as the capability information 1209, and the capability information 1302 in FIG. 13A may include the same information as the capability information 1210 described with reference to FIG. 12 and may be transmitted in a same manner as the capability information 1210.

At 1303, the first UE 1204 may power ON its first radio (e.g., the first radio circuit 906, 1006). The first UE 1204 may transmit a first message 1304 using its first radio (e.g., the first radio circuit 906, 1006) and resources associated with the mobile network. The first message 1304 may indicate a first preferred DRX mode configuration for the first radio of the first UE 1204 and/or a second preferred DRX mode configuration for the second radio of the first UE 1204.

The second UE 1208 may transmit a second message 1306 indicating a third preferred DRX mode configuration for the second radio of the first UE 1204. In some aspects, the third preferred DRX mode configuration in the second message 1306 may enable at least the first radio (e.g., the first radio circuit 906, 1006) of the first UE 1204 or the second radio (e.g., the second radio circuit 908, 1008) of the first UE 1204 to have an active time in a DRX cycle that at least partially overlaps with an active time in a DRX cycle of a radio at the second UE 1208.

The first UE 1204 may use its first radio (e.g., the first radio circuit 906, 1006) to receive configuration information 1308 from the network node 1202. The configuration information 1308 may include at least a first DRX mode configuration for the first radio (e.g., the first radio circuit 906, 1006) of the first UE 1204 and a second DRX mode configuration for the second radio (e.g., the second radio circuit 908, 1008) of the first UE 1204. In some examples, the configuration information 1308 may indicate a certain DRX mode configuration to be used for the first radio (e.g., the first radio circuit 906, 1006) of the first UE 1204 and/or the second radio (e.g., the second radio circuit 908, 1008) of the first UE 1204.

In some examples, the first DRX mode configuration for the first radio indicated in the configuration information 1308 may be based on the first preferred DRX mode configuration. In some examples, the second DRX mode configuration for the second radio indicated in the configuration information 1308 may be based on the second preferred DRX mode configuration. In some examples, the configuration information 1308 may indicate to use the third preferred DRX mode configuration for the first radio or the second radio of the first UE 1204.

In some examples, a DRX cycle based on the first DRX mode configuration for the first radio (e.g., the first radio circuit 906, 1006) of the first UE 1204 is different from a DRX cycle based on the second DRX mode configuration for the second radio (e.g., the second radio circuit 908, 1008) of the first UE 1204. For example, the first DRX mode configuration for the first radio (e.g., the first radio circuit 906, 1006) of the first UE 1204 may be the first DRX mode configuration 1100 illustrated in FIG. 11A and the second DRX mode configuration for the second radio (e.g., the second radio circuit 908, 1008) of the first UE 1204 may be the third DRX mode configuration 1180 illustrated in FIG. 11C. In this example, it should be noted that the second DRX active time 1108 of the second DRX cycle duration 1104 is nonoverlapping with the second DRX active time 1188 of the second DRX cycle duration 1184.

In some examples, a DRX cycle based on the first DRX mode configuration for the first radio (e.g., the first radio circuit 906, 1006) of the first UE 1204 is the same as a DRX cycle based on a second DRX mode configuration for the second radio (e.g., the second radio circuit 908, 1008) of the first UE 1204. For example, the first DRX mode configuration for the first radio (e.g., the first radio circuit 906, 1006) of the first UE 1204 and the second DRX mode configuration for the second radio (e.g., the second radio circuit 908, 1008) of the first UE 1204 may be the same DRX mode configuration (e.g., the first DRX mode configuration 1100 illustrated in FIG. 11A).

In some aspects, the configuration information 1308 may further include at least one of a set of frequencies to be supported by the second radio (e.g., the second radio circuit 908, 1008) of the first UE 1204, one or more time-frequency allocations, a first set of configuration settings that enables a signal reception at the second radio (e.g., the second radio circuit 908, 1008) of the first UE 1204, a second set of configuration settings that enables a signal transmission from the second radio (e.g., the second radio circuit 908, 1008) of the first UE 1204, or control information.

In some aspects, and as shown in FIG. 13A, the second UE 1208 may receive all or a portion of the configuration information 1308. Therefore, in some examples, the second UE 1208 may receive information indicating a first DRX cycle of the first radio of the first UE 1204 and a second DRX cycle of the second radio of the first UE 1204.

The first UE 1204 may receive, using its first radio (e.g., the first radio circuit 906, 1006), configuration information 1312 associated with the second radio (e.g., the second radio circuit 908, 1008) of the first UE 1204. For example, the configuration information 1312 may include a set of frequencies to be supported by the second radio (e.g., the second radio circuit 908, 1008) of the first UE 1204, one or more time-frequency allocations, and/or a set of configuration settings that enables a signal reception (e.g., from the second UE 1208) at the second radio (e.g., the second radio circuit 908, 1008) of the first UE 1204.

At 1314, the first UE 1204 powers ON its second radio (e.g., the second radio circuit 908, 1008).

At 1316, the first UE 1204 operates its first radio (e.g., the first radio circuit 906, 1006) based on the first DRX mode configuration and operates its second radio (e.g., the second radio circuit 908, 1008) based on the second DRX mode configuration.

In some aspects, the first UE 1204 may be equipped with multiple wakeup receiver circuits (e.g., the first wakeup receiver circuit 912 and the second wakeup receiver circuit 914). In these aspects, the first UE 1204 may receive a first wakeup signal (WUS_1) 1318 for its first radio (e.g., the first radio circuit 906, 1006) and/or a second wakeup signal (WUS_2) 1320 for its second radio (e.g., the second radio circuit 908, 1008). In some examples, the first wakeup signal (WUS_1) 1318 and the second wakeup signal (WUS_2) 1320 may respectively be the first wakeup signal (WUS_1) 938 and the second wakeup signal (WUS_2) 940 described with reference to FIG. 9.

For example, if the first UE 1204 receives the first wakeup signal 1318 at the first wakeup receiver circuit (e.g., the first wakeup receiver circuit 912), the first wakeup receiver circuit may transition the first radio (e.g., the first radio circuit 906, 1006) to an awake mode. If the first UE 1204 receives the second wakeup signal 1320 at the second wakeup receiver circuit (e.g., the second wakeup receiver circuit 914), the second wakeup receiver circuit may transition the second radio (e.g., the second radio circuit 908, 1008) to the awake mode. If the first UE 1204 has the capability to concurrently operate both its first radio (e.g., the first radio circuit 906, 1006) and its second radio (e.g., the second radio circuit 908, 1008) and the first UE 1204 receives both the first and second wakeup signals 1318, 1320, it should be understood that both the first radio (e.g., the first radio circuit 906, 1006) and the second radio (e.g., the second radio circuit 908, 1008) of the first UE 1204 may transition to the awake mode.

In some aspects, the first UE 1204 may be equipped with a single wakeup receiver circuit (e.g., the wakeup receiver circuit 1012). In these aspects, the first UE 1204 may receive a third wakeup signal (WUS_3) 1322 for the first and second radios (e.g., the first radio circuit 906, 1006 and the second radio circuit 908, 1008) of the first UE 1204 at the single wakeup receiver circuit.

For example, if the first UE 1204 receives the third wakeup signal 1322 at the single wakeup receiver circuit (e.g., the wakeup receiver circuit 1012), the single wakeup receiver circuit may transition the first radio (e.g., the first radio circuit 906, 1006) and/or the second radio (e.g., the second radio circuit 908, 1008) to an awake mode based on information (e.g., a two-bit value of the previously described wakeup indication) in the third wakeup signal 1322.

The first UE 1204 can have the same or different DRX cycles for both its first and second radios. In some scenarios, if the two radios of the first UE 1204 (e.g., the first radio circuit 906, 1006 and the second radio circuit 908, 1008) cannot be enabled together, then their DRX cycles are not overlapped (e.g., the active times of their DRX cycles are not overlapped). If the DRX cycles of the first and second radios of the first UE 1204 do not overlap (e.g., the active times of their DRX cycles are not overlapped), then different WUS signals may be used to wake up the first and second radios of the first UE 1204.

With reference to FIG. 13B, if the first UE 1204 is equipped with multiple wakeup receiver circuits (e.g., the first wakeup receiver circuit 912 and the second wakeup receiver circuit 914) as previously discussed, the first UE 1204 may receive, from the second UE 1208, a first wakeup signal (WUS_1) 1324 for its first radio (e.g., the first radio circuit 906, 1006) at a first wakeup receiver circuit (e.g., the first wakeup receiver circuit 912) and/or a second wakeup signal (WUS_2) 1326 for its second radio (e.g., the second radio circuit 908, 1008) at a second wakeup receiver circuit (e.g., the second wakeup receiver circuit 914).

If the first UE 1204 is equipped with a single wakeup receiver circuit (e.g., the wakeup receiver circuit 1012) as previously discussed, the first UE 1204 may receive, from the second UE 1208, a third wakeup signal (WUS_3) 1322 for the first and second radios (e.g., the first radio circuit 906, 1006 and the second radio circuit 908, 1008) at the single wakeup receiver circuit of the first UE 1204. The single wakeup receiver circuit of the first UE 1204 may transition the first radio (e.g., the first radio circuit 906, 1006) and/or the second radio (e.g., the second radio circuit 908, 1008) to an awake mode based on information (e.g., a two-bit value of the previously described wakeup indication) in the third wakeup signal (WUS_3) 1322.

For example, the first wakeup signal (WUS_1) 1324 may be the first wakeup signal (WUS_1) 938 described with reference to FIG. 9, the second wakeup signal (WUS_2) 1326 may be the second wakeup signal (WUS_2) 940 described with reference to FIG. 9, and the third wakeup signal (WUS_3) 1328 may be the wakeup signal (WUS_3) 1034 described with reference to FIG. 10.

In some aspects, the first UE 1204 may receive a signal 1329 from the second UE 1208. For example, the first UE 1204 may receive the signal 1329 during an active time of a DRX cycle of its first radio (e.g., the first radio circuit 906, 1006). For example, the signal 1329 may include data, configuration information, a command for the first UE 1204, or a request for the first UE 1204.

In some aspects, the first UE 1204 may receive and decode a backscattered signal from the passive device 1206 (e.g., an RFID tag), where the passive device 1206 backscatters the signal in response to a CW signal from the second UE 1208. For example, with reference to FIG. 13B, the second UE 1208 may transmit a CW signal 1330. The passive device 1206 (e.g., an RFID tag) may backscatter a signal 1332 in response to the CW signal 1330.

At 1334, the first UE 1204 may decode the signal 1332 to determine information included in the signal 1332.

The first UE 1204 may receive a message 1336 from the network node 1202. The message 1336 may include a request to transmit a first communication using the first radio (e.g., the first radio circuit 906, 1006), a second communication using the second radio (e.g., the second radio circuit 908, 1008), or both the first communication and the second communication using the first radio and the second radio. In some examples, at least a portion of the first and second communications may be the same.

At 1338, the first UE 1204 may transmit a first signal 1340 using the first radio (e.g., the first radio circuit 906, 1006) and a second signal 1342 using the second radio (e.g., the second radio circuit 908, 1008). The first UE 1204 may transmit at least a portion of the first signal 1340 concurrently with at least a portion of the second signal 1342. In some aspects, the first UE 1204 may transmit the first and second signals 1340, 1342 in response to the request in the message 1336. In some examples, the second signal 1342 may be a CW signal for the passive device 1206.

At 1344, the first UE 1204 may receive a first signal 1346 using the first radio (e.g., the first radio circuit 906, 1006) and a second signal 1348 using the second radio (e.g., the second radio circuit 908, 1008). The first UE 1204 may receive at least a portion of the first signal 1346 concurrently with at least a portion of the second signal 1348. In some examples, the second signal 1342 may be a backscattered signal from the passive device 1206 (e.g., an RFID tag).

In some aspects, the first UE 1204 may receive a first signal 1350 using the first radio (e.g., the first radio circuit 906, 1006) and may transit a second signal 1352 using the second radio (e.g., the second radio circuit 908, 1008). The first UE 1204 may receive at least a portion of the first signal 1350 using its first radio while transmitting at least a portion of the second signal 1352 using its second radio.

In some aspects, the first UE 1204 may transmit a first signal 1354 using its first radio (e.g., the first radio circuit 906, 1006) and may receive a second signal 1356 using its second radio (e.g., the second radio circuit 908, 1008). The first UE 1204 may transmit at least a portion of the first signal 1354 using its first radio while receiving at least a portion of the second signal 1356 using its second radio.

In some aspects of the disclosure, the first UE 1204 may prioritize one or more communications to and/or from the first UE 1204 based on a set of priority rules. For example, if the first UE 1204 is capable of using both its first and second radios for communication at the same time, the first UE 1204 may assign a priority to each transmission or reception associated with a certain radio (e.g., the first radio circuit 906, 1006 or the second radio circuit 908, 1008).

In one example, when a transmission or reception of a first signal using the first radio (e.g., the first radio circuit 906, 1006) of the first UE 1204 is overlapping with a transmission or reception of a second signal using the second radio (e.g., the second radio circuit 908, 1008) of the first UE 1204, the first UE 1204 may determine that one signal (e.g., the first signal 1340, 1346, 1350, 1354) has a higher priority than another signal (e.g., the second signal 1342, 1348, 1352, 1356). In some aspects, the first UE 1204 may use the determined priority to control one or more characteristics of the transmission or reception of the first signal and/or the transmission or reception of the second signal. For example, the first UE 1204 may apply a higher quality of service (QoS) to a transmission or reception of a signal determined to have higher priority than a signal determined to have lower priority.

In some aspects of the disclosure, the first UE 1204 may control a transmission power of one or more communications from the first UE 1204 based on a set of transmission power control rules. For example, if the first UE 1204 is capable of using both its first and second radios for communication at the same time (also referred to as overlapping communications), the first UE 1204 may apply a first transmission power for transmission of a first signal from the first radio and a second transmission power for transmission of a second signal from the second radio based on the set of transmission power control rules. In one example, the set of transmission power control rules may indicate that a transmission power for the second signal from the second radio is to be set below a threshold value if the first signal from the first radio includes control information (e.g., a transmission on PDCCH).

In some aspects of the disclosure, the message 1336 includes a request to transmit data. The request may indicate to transmit the data using the first radio, the second radio, or both the first radio and the second radio of the first UE 1204. The first UE 1204 may select the first radio, the second radio, or both the first radio and the second radio for transmission of the data based on a transmission power associated with the data, a priority of the first radio, a priority of the second radio, and an available power of the apparatus. The first UE 1204 may transmit the data based on the selection (e.g., in the first signal 1340, 1346, 1350, 1354 and/or the second signal 1342, 1348, 1352, 1356).

FIG. 14 illustrates a first UE 1404 in communication with a second UE 1440. In some examples, the first UE 1404 may be the first UE 1204 described herein and the second UE 1440 may be the second UE 1208 described herein.

The first UE 1404 includes a first radio circuit 1406 coupled to a first antenna 1414, and a second radio circuit 1408 coupled to a second antenna 1416. In some aspects, the first radio circuit 1406 may enable wireless communication using resources of a mobile network (e.g., a 5G NR network, an LTE network, etc.) or other type of network (e.g., a local area network (LAN), such as a Wi-Fi network). The second radio circuit 1408 may enable wireless communication with a passive device (e.g., an RFID tag).

The second UE 1440 includes a first radio circuit 1446 coupled to a first antenna 1444 and a second radio circuit 1448 coupled to a second antenna 1447. In some aspects, the first radio circuit 1446 may enable wireless communication using resources of a mobile network (e.g., a 5G NR network, an LTE network, etc.) or other type of network (e.g., a local area network (LAN), such as a Wi-Fi network). The second radio circuit 1448 may enable wireless communication with a passive device (e.g., a PIoT device, such as an RFID tag).

In the first UE 1404, the first radio circuit 1406 may communicate with the second radio circuit 1408 via a data path 1422. In some examples, the first radio circuit 1406 can control the second radio circuit 1408 by transmitting commands (e.g., control information) via the data path 1422. In the second UE 1440, the first radio circuit 1446 may communicate with the second radio circuit 1448 via a data path 1442. In some examples, the first radio circuit 1446 can control the second radio circuit 1448 by transmitting commands (e.g., control information) via the data path 1442.

In some examples, the first UE 1404 may communicate 1480 with the second UE 1440 via PC5 signaling. In some examples, the first UE 1404 may communicate 1490 with the second UE 1440 via continuous wave (CW) signaling. In some examples, the first UE 1404 may communicate 1480, 1490 concurrently with the second radio 1448 using the first and second radio circuits 1406, 1408.

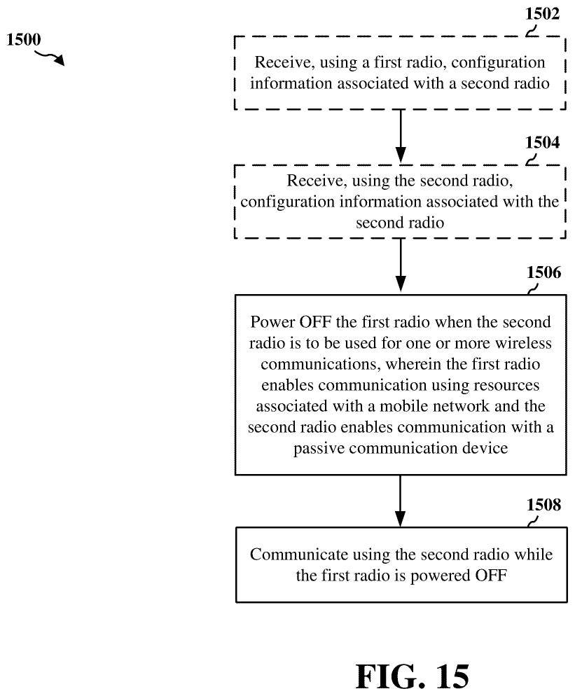

FIG. 15 is a flowchart 1500 of a method of wireless communication. The method may be performed by a UE (e.g., the UE 104, 904, 1004, 1204, 1404; the apparatus 1902/1902′; the processing system 2014, which may include the memory 360 and which may be the entire UE or a component of the UE, such as the TX processor 368, the RX processor 356, and/or the controller/processor 359). It should be understood that blocks indicated with dashed lines in FIG. 15 represent optional blocks.

At 1502, the UE receives, using a first radio, configuration information associated with a second radio. For example, with reference to FIG. 12, the configuration information may be the configuration information 1211 from the network node 1202. In some examples, the configuration information includes at least one of configuration information for a discontinuous reception mode for the second radio, a set of frequencies to be supported by the second radio, one or more time-frequency allocations, a first set of configuration settings that enables a signal reception at the second radio, a second set of configuration settings that enables a signal transmission from the second radio, or control information.

At 1504, the UE receives, using the second radio, configuration information associated with the second radio. For example, with reference to FIG. 12, the configuration information associated with the second radio may be configuration information 1212 from the second UE 1208. In some examples, the configuration information includes at least a set of frequencies to be supported by the second radio.

At 1506, the UE powers OFF the first radio when the second radio is to be used for one or more wireless communications, wherein the first radio enables communication using resources associated with a mobile network and the second radio enables communication with a passive communication device.

For example, with reference to FIG. 12, at 1214, the first UE 1204 may power OFF its first radio (e.g., the first radio circuit 906, 1006) that enables communication using resources associated with a mobile network. In some aspects, the first UE 1204 may power OFF its first radio (e.g., the first radio circuit 906, 1006) when its second radio (e.g., the second radio circuit 908, 1008) is to be used for one or more wireless communications. For example, the first UE 1204 may power OFF its first radio when its second radio is to be used to transmit to or receive from the passive device 1206 and/or the second UE 1208.

At 1508, the UE communicates using the second radio while the first radio is powered OFF.

In some examples, the passive communication device may be the passive device 1206 described with reference to FIG. 12. In some aspects, if the passive communication device includes an RFID tag, the UE communicates using its second radio while the first radio is powered OFF by receiving a signal (e.g., the signal 1222, 1228) using the second radio from the RFID tag. In some examples, a frequency of the signal is one of a set of frequencies preconfigured at the UE for the second radio. The UE then decodes the signal (e.g., the signal 1222, 1228) to determine information included in the signal.

In some aspects, if the passive communication device includes an RFID tag, the UE communicates using its second radio while the first radio is powered OFF by transmitting a signal (e.g., the modulated signal 1218, the CW signal 1220, 1232) using its second radio to the RFID tag, where a frequency of the signal is one of a set of frequencies preconfigured at the apparatus for the second radio. In some aspects, the transmitted signal is the modulated signal 1218, which may include information (e.g., data) to be stored at the RFID tag.

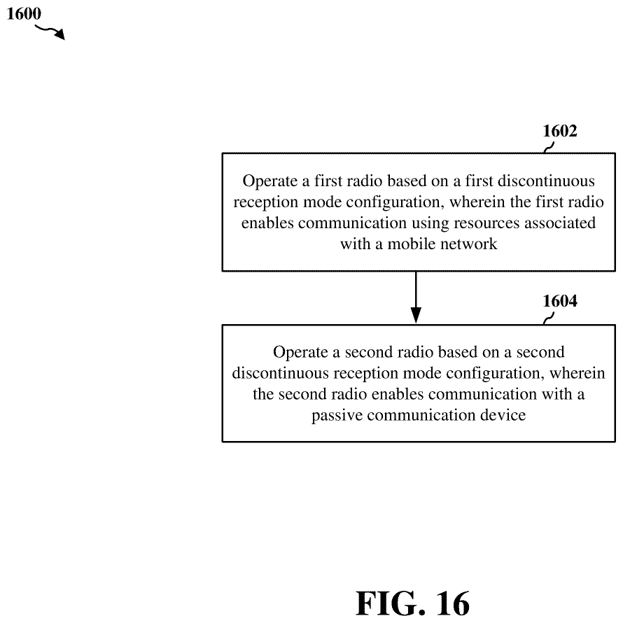

FIG. 16 is a flowchart 1600 of a method of wireless communication. The method may be performed by a UE (e.g., the UE 104, 904, 1004, 1204, 1404; the apparatus 1902/1902′; the processing system 2014, which may include the memory 360 and which may be the entire UE or a component of the UE, such as the TX processor 368, the RX processor 356, and/or the controller/processor 359).

At 1602, the UE operates a first radio based on a first DRX mode configuration, wherein the first radio enables communication using resources associated with a mobile network. For example, the first DRX mode configuration for the first radio (e.g., the first radio circuit 906, 1006) of the first UE 1204 may be the first DRX mode configuration 1100 illustrated in FIG. 11A.

At 1604, the UE operates a second radio based on a second DRX mode configuration, wherein the second radio enables communication with a passive communication device. For example, the second DRX mode configuration for the second radio (e.g., the second radio circuit 908, 1008) of the first UE 1204 may be the third DRX mode configuration 1180 illustrated in FIG. 11C.

In some examples, a first DRX cycle based on the first DRX mode configuration is different from a second DRX cycle based on the second DRX mode configuration. In some examples, an active time of the first discontinuous reception cycle is nonoverlapping with an active time of the second discontinuous reception cycle. In other examples, a first DRX cycle based on the first DRX mode configuration is the same as a second DRX cycle based on the second DRX mode configuration.

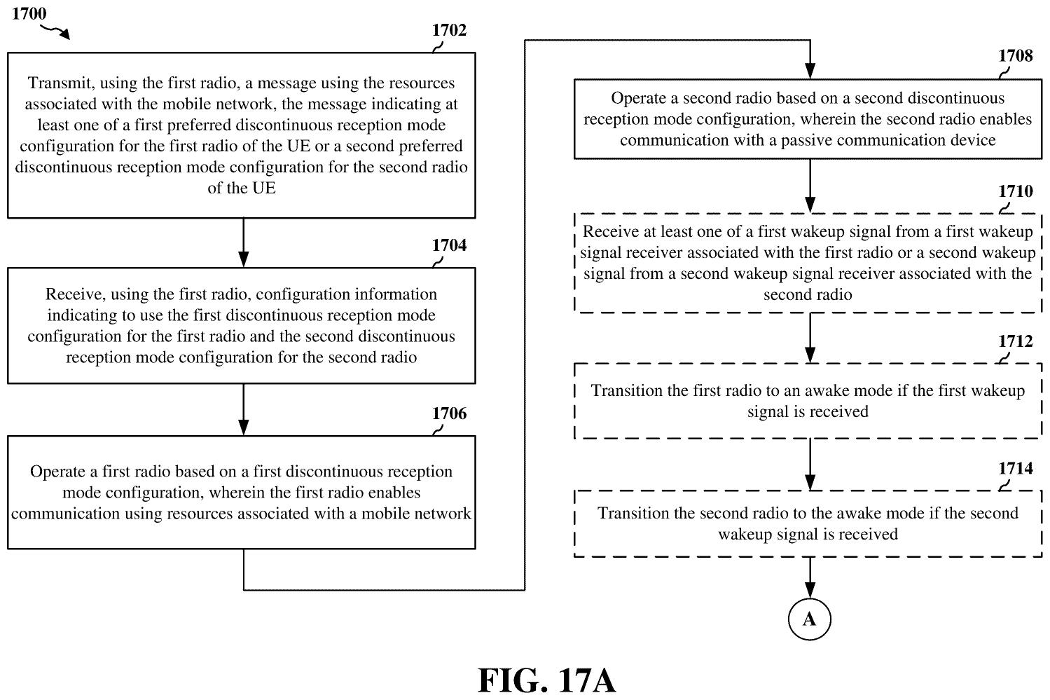

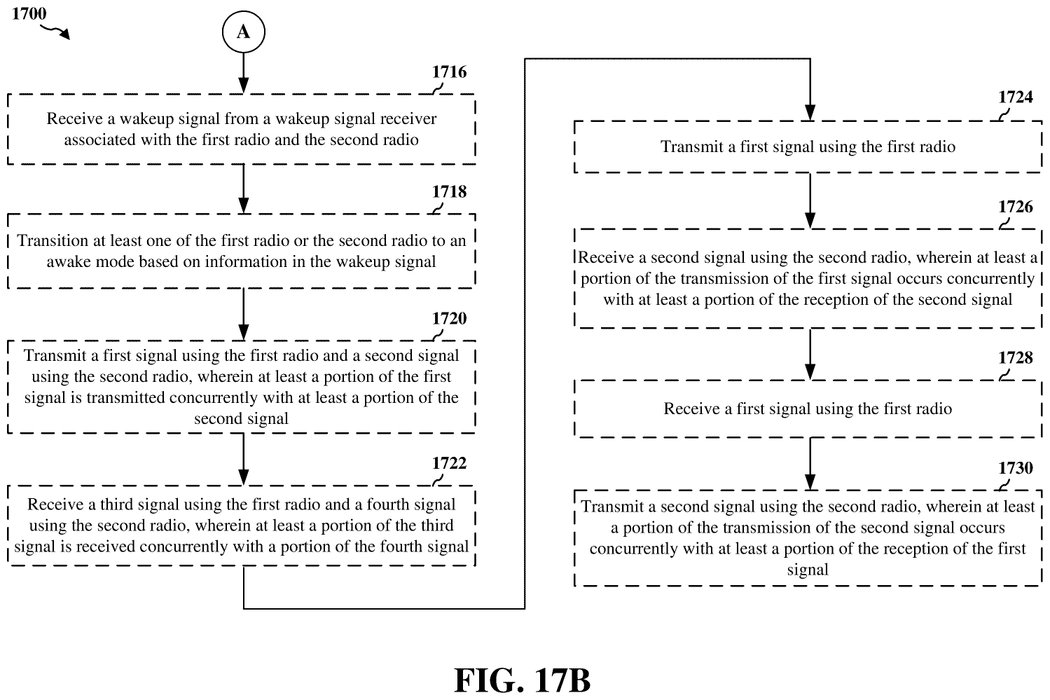

FIGS. 17A and 17B are a flowchart 1700 of a method of wireless communication. The method may be performed by a UE (e.g., the UE 104, 904, 1004, 1204, 1404; the apparatus 1902/1902′; the processing system 2014, which may include the memory 360 and which may be the entire UE or a component of the UE, such as the TX processor 368, the RX processor 356, and/or the controller/processor 359). It should be understood that blocks indicated with dashed lines in FIGS. 17A and 17B represent optional blocks.

At 1702, the UE transmits, using the first radio, a message using the resources associated with the mobile network, the message indicating at least one of a first preferred DRX mode configuration for the first radio of the apparatus or a second preferred DRX mode configuration for the second radio of the apparatus. For example, with reference to FIG. 13A, the first UE 1204 may transmit a first message 1304 using its first radio (e.g., the first radio circuit 906, 1006) and resources associated with the mobile network. The first message 1304 may indicate a first preferred DRX mode configuration for the first radio of the first UE 1204 and/or a second preferred DRX mode configuration for the second radio of the first UE 1204.

At 1704, the UE receives, using the first radio, configuration information indicating to use the first DRX mode configuration for the first radio and the second DRX mode configuration for the second radio. For example, with reference to FIG. 13A, the first UE 1204 may use its first radio (e.g., the first radio circuit 906, 1006) to receive configuration information 1308 from the network node 1202. The configuration information 1308 may include at least a first DRX mode configuration for the first radio (e.g., the first radio circuit 906, 1006) of the first UE 1204 and a second DRX mode configuration for the second radio (e.g., the second radio circuit 908, 1008) of the first UE 1204. In some examples, the first DRX mode configuration for the first radio is based on the first preferred DRX mode configuration. In some examples, the second DRX mode configuration for the second radio is based on the second preferred DRX mode configuration.

At 1706, the UE operates a first radio based on a first DRX mode configuration, wherein the first radio enables communication using resources associated with a mobile network. For example, the first DRX mode configuration for the first radio (e.g., the first radio circuit 906, 1006) of the first UE 1204 may be the first DRX mode configuration 1100 illustrated in FIG. 11A. In some aspects, the first discontinuous reception mode configuration for the first radio is based on the first preferred discontinuous reception mode configuration.

At 1708, the UE operates a second radio based on a second DRX mode configuration, wherein the second radio enables communication with a passive communication device. For example, the second DRX mode configuration for the second radio (e.g., the second radio circuit 908, 1008) of the first UE 1204 may be the third DRX mode configuration 1180 illustrated in FIG. 11C. In some aspects, the second discontinuous reception mode configuration for the second radio is based on the second preferred discontinuous reception mode configuration.

In some examples, a first DRX cycle based on the first DRX mode configuration is different from a second DRX cycle based on the second DRX mode configuration. In some examples, an active time of the first discontinuous reception cycle is nonoverlapping with an active time of the second discontinuous reception cycle. In other examples, a first DRX cycle based on the first DRX mode configuration is the same as a second DRX cycle based on the second DRX mode configuration.

At 1710, the UE receives at least one of a first wakeup signal from a first wakeup signal receiver associated with the first radio or a second wakeup signal from a second wakeup signal receiver associated with the second radio. For example, with reference to FIG. 13A, the first UE 1204 may receive a first wakeup signal (WUS_1) 1318 for its first radio (e.g., the first radio circuit 906, 1006) and/or a second wakeup signal (WUS_2) 1320 for its second radio (e.g., the second radio circuit 908, 1008). In some examples, the first wakeup signal (WUS_1) 1318 and the second wakeup signal (WUS_2) 1320 may respectively be the first wakeup signal (WUS_1) 938 and the second wakeup signal (WUS_2) 940 described with reference to FIG. 9.

For example, with reference to FIG. 13B, if the first UE 1204 is equipped with multiple wakeup receiver circuits (e.g., the first wakeup receiver circuit 912 and the second wakeup receiver circuit 914) as previously discussed, the first UE 1204 may receive, from the second UE 1208, a first wakeup signal (WUS_1) 1324 for its first radio (e.g., the first radio circuit 906, 1006) at a first wakeup receiver circuit (e.g., the first wakeup receiver circuit 912) and/or a second wakeup signal (WUS_2) 1326 for its second radio (e.g., the second radio circuit 908, 1008) at a second wakeup receiver circuit (e.g., the second wakeup receiver circuit 914).

At 1712, the UE transitions the first radio to an awake mode if the first wakeup signal is received. For example, with reference to FIG. 9, if the UE 904 receives the first wakeup signal 938 at the first antenna 916 prior to an active time of a DRX cycle of the first radio circuit 906, the first wakeup receiver circuit 912 may provide the first wakeup signal 938 to the processing circuit 910 via the data path 932. The processing circuit 910 may provide the first wakeup signal 938 to the first radio circuit 906 via the data path 920. The first radio circuit 906 may wake up (e.g., transition to an awake mode) in response to the first wakeup signal 938 during the active time of the DRX cycle of the first radio circuit 906.

At 1714, the UE transitions the second radio to the awake mode if the second wakeup signal is received. For example, with reference to FIG. 9, if the UE 904 receives the second wakeup signal 940 at the second antenna 918 prior to an active time of a DRX cycle of the second radio circuit 908, the second wakeup receiver circuit 914 may provide the second wakeup signal 940 to the processing circuit 910 via the data path 936. The processing circuit 910 may provide the second wakeup signal 940 to the second radio circuit 908 via the data path 922. The second radio circuit 908 may wake up (e.g., transition to an awake mode) in response to the second wakeup signal 940 during the active time of the DRX cycle of the second radio circuit 908.

With reference to FIG. 17B, at 1716, the UE receives a wakeup signal from a wakeup signal receiver associated with the first radio and the second radio. For example, with reference to FIG. 10, the first radio circuit 1006 may be operating in a DRX mode based on a first DRX mode configuration and the second radio circuit 1008 may be operating in the DRX mode based on a second DRX mode configuration. The UE 1004 may receive a wakeup signal (WUS_3) 1034 at the first antenna 1014. The wakeup signal 1034 may be configured to wake up (e.g., transition to an awake mode) the first radio circuit 1006, the second radio circuit 1008, or both the first and second radio circuits 1006, 1008.

For example, the first UE 1204 may receive the third wakeup signal (WUS_3) 1322 for the first and second radios (e.g., the first radio circuit 906, 1006 and the second radio circuit 908, 1008) of the first UE 1204 at a single wakeup receiver circuit (e.g., the wakeup receiver circuit 1012). In another example, with reference to FIG. 13B, the first UE 1204 may receive the third wakeup signal (WUS_3) 1328.

At 1718, the UE transitions at least one of the first radio or the second radio to an awake mode based on information in the wakeup signal. For example, with reference to FIG. 10, the wakeup receiver circuit 1012 may be configured to provide the wakeup signal 1034 to the processing circuit 1010 via the data path 1024. The processing circuit 1010 may determine whether the wakeup indication in the wakeup signal 1034 is set to the first value, the second value, or the third value and may transition the first radio circuit 1006 and/or the second radio circuit 1008 to an awake mode based on the value of the wakeup indication.

For example, the processing circuit 1010 may transition the first radio circuit 1006 to the awake mode by transmitting a control signal to the first radio circuit 1006 via the data path 1018. For example, the processing circuit 1010 may transition the second radio circuit 1008 to the awake mode by transmitting a control signal to the second radio circuit 1008 via the data path 1020.

At 1720, the UE transmits a first signal using the first radio and a second signal using the second radio, wherein at least a portion of the first signal is transmitted concurrently with at least a portion of the second signal. For example, with reference to FIG. 13B, at 1338, the first UE 1204 may transmit a first signal 1340 using the first radio (e.g., the first radio circuit 906, 1006) and a second signal 1342 using the second radio (e.g., the second radio circuit 908, 1008). The first UE 1204 may transmit at least a portion of the first signal 1340 concurrently with at least a portion of the second signal 1342.

At 1722, the UE receives a third signal using the first radio and a fourth signal using the second radio, wherein at least a portion of the third signal is received concurrently with a portion of the fourth signal. For example, with reference to FIG. 13B, at 1344, the third signal may be the first signal 1346 and the fourth signal may be the second signal 1348. The first UE 1204 may receive at least a portion of the first signal 1346 concurrently with at least a portion of the second signal 1348.

At 1724, the UE transmits a first signal using the first radio. For example, with reference to FIG. 13B, the first UE 1204 may transmit a first signal 1354 using its first radio (e.g., the first radio circuit 906, 1006).

At 1726, the UE receives a second signal using the second radio, wherein at least a portion of the transmission of the first signal occurs concurrently with at least a portion of the reception of the second signal. For example, with reference to FIG. 13B, the first UE 1204 may receive a second signal 1356 using its second radio (e.g., the second radio circuit 908, 1008). The first UE 1204 may transmit at least a portion of the first signal 1354 using its first radio while receiving at least a portion of the second signal 1356 using its second radio.

At 1728, the UE receives a first signal using the first radio. For example, with reference to FIG. 13B, the first UE 1204 may receive the first signal 1350 using the first radio (e.g., the first radio circuit 906, 1006).

At 1730, the UE transmits a second signal using the second radio, wherein at least a portion of the transmission of the second signal occurs concurrently with at least a portion of the reception of the first signal. For example, with reference to FIG. 13B, the first UE 1204 may transit the second signal 1352 using the second radio (e.g., the second radio circuit 908, 1008). The first UE 1204 may receive at least a portion of the first signal 1350 using its first radio while transmitting at least a portion of the second signal 1352 using its second radio.

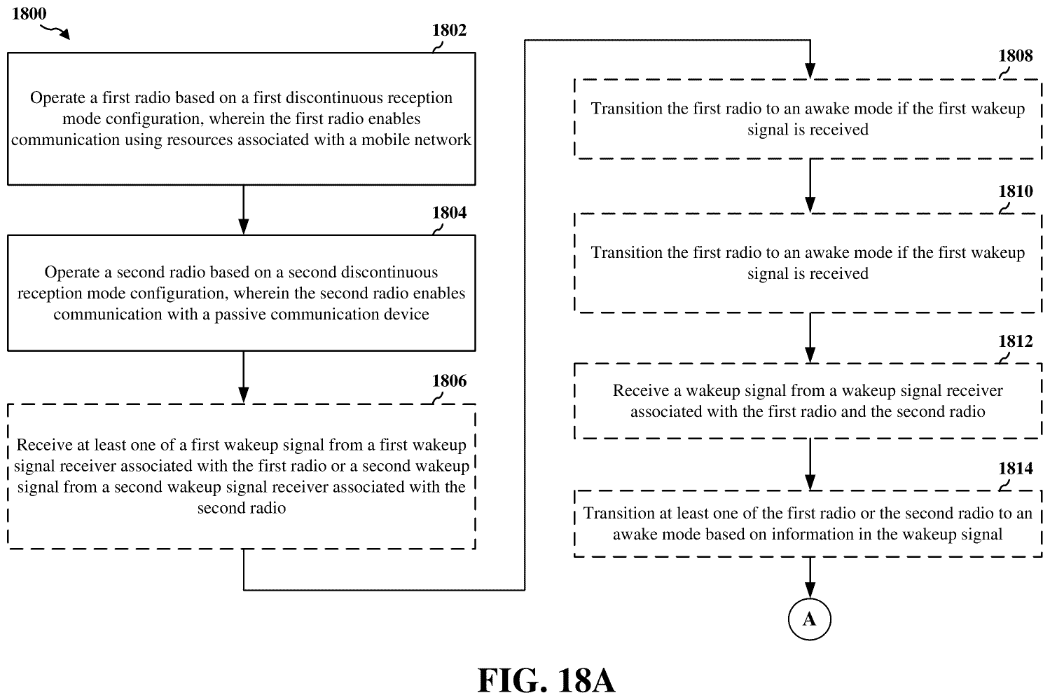

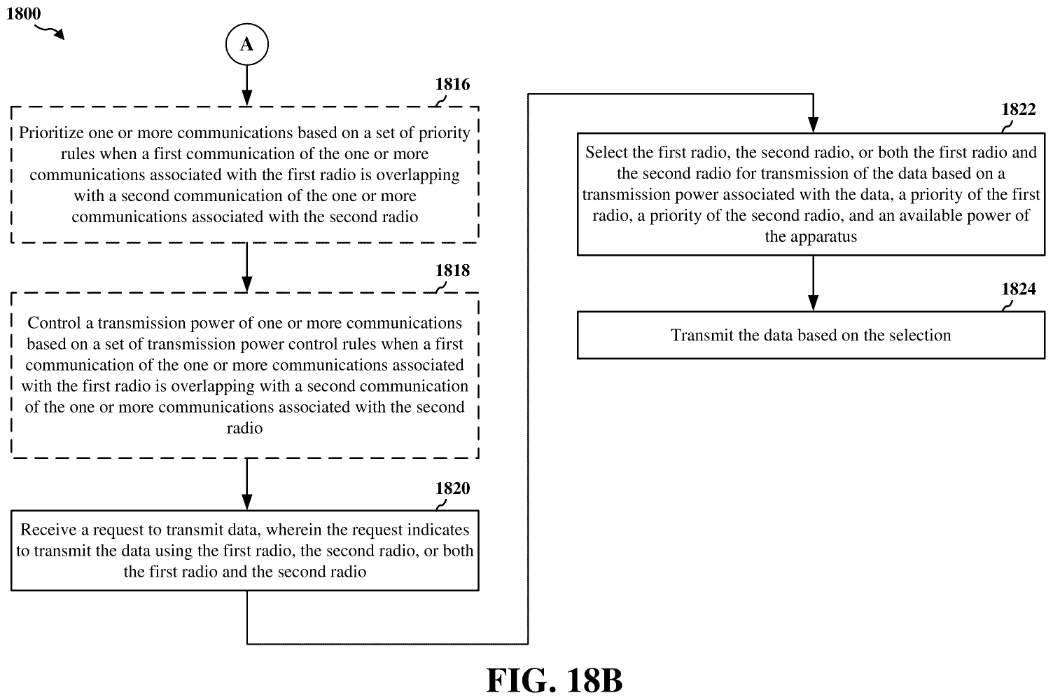

FIGS. 18A and 18B are a flowchart 1800 of a method of wireless communication. The method may be performed by a UE (e.g., the UE 104, 904, 1004, 1204, 1404; the apparatus 1902/1902′; the processing system 2014, which may include the memory 360 and which may be the entire UE or a component of the UE, such as the TX processor 368, the RX processor 356, and/or the controller/processor 359). It should be understood that blocks indicated with dashed lines in FIGS. 18A and 18B represent optional blocks.

At 1802, the UE operates a first radio based on a first DRX mode configuration, wherein the first radio enables communication using resources associated with a mobile network. For example, the first DRX mode configuration for the first radio (e.g., the first radio circuit 906, 1006) of the first UE 1204 may be the first DRX mode configuration 1100 illustrated in FIG. 11A.

At 1804, the UE operates a second radio based on a second DRX mode configuration, wherein the second radio enables communication with a passive communication device. For example, the second DRX mode configuration for the second radio (e.g., the second radio circuit 908, 1008) of the first UE 1204 may be the third DRX mode configuration 1180 illustrated in FIG. 11C.

At 1806, the UE receives at least one of a first wakeup signal from a first wakeup signal receiver associated with the first radio or a second wakeup signal from a second wakeup signal receiver associated with the second radio. For example, with reference to FIG. 13A, the first UE 1204 may receive a first wakeup signal (WUS_1) 1318 for its first radio (e.g., the first radio circuit 906, 1006) and/or a second wakeup signal (WUS_2) 1320 for its second radio (e.g., the second radio circuit 908, 1008). In some examples, the first wakeup signal (WUS_1) 1318 and the second wakeup signal (WUS_2) 1320 may respectively be the first wakeup signal (WUS_1) 938 and the second wakeup signal (WUS_2) 940 described with reference to FIG. 9.

For example, with reference to FIG. 13B, if the first UE 1204 is equipped with multiple wakeup receiver circuits (e.g., the first wakeup receiver circuit 912 and the second wakeup receiver circuit 914) as previously discussed, the first UE 1204 may receive, from the second UE 1208, a first wakeup signal (WUS_1) 1324 for its first radio (e.g., the first radio circuit 906, 1006) at a first wakeup receiver circuit (e.g., the first wakeup receiver circuit 912) and/or a second wakeup signal (WUS_2) 1326 for its second radio (e.g., the second radio circuit 908, 1008) at a second wakeup receiver circuit (e.g., the second wakeup receiver circuit 914).

At 1808, the UE transitions the first radio to an awake mode if the first wakeup signal is received. For example, with reference to FIG. 9, if the UE 904 receives the first wakeup signal 938 at the first antenna 916 prior to an active time of a DRX cycle of the first radio circuit 906, the first wakeup receiver circuit 912 may provide the first wakeup signal 938 to the processing circuit 910 via the data path 932. The processing circuit 910 may provide the first wakeup signal 938 to the first radio circuit 906 via the data path 920. The first radio circuit 906 may wake up (e.g., transition to an awake mode) in response to the first wakeup signal 938 during the active time of the DRX cycle of the first radio circuit 906.

At 1810, the UE transitions the second radio to the awake mode if the second wakeup signal is received. For example, with reference to FIG. 9, if the UE 904 receives the second wakeup signal 940 at the second antenna 918 prior to an active time of a DRX cycle of the second radio circuit 908, the second wakeup receiver circuit 914 may provide the second wakeup signal 940 to the processing circuit 910 via the data path 936. The processing circuit 910 may provide the second wakeup signal 940 to the second radio circuit 908 via the data path 922. The second radio circuit 908 may wake up (e.g., transition to an awake mode) in response to the second wakeup signal 940 during the active time of the DRX cycle of the second radio circuit 908.

At 1812, the UE receives a wakeup signal from a wakeup signal receiver associated with the first radio and the second radio. For example, with reference to FIG. 10, the first radio circuit 1006 may be operating in a DRX mode based on a first DRX mode configuration and the second radio circuit 1008 may be operating in the DRX mode based on a second DRX mode configuration. The UE 1004 may receive a wakeup signal (WUS_3) 1034 at the first antenna 1014. The wakeup signal 1034 may be configured to wake up (e.g., transition to an awake mode) the first radio circuit 1006, the second radio circuit 1008, or both the first and second radio circuits 1006, 1008. In another example, with reference to FIG. 13B, the first UE 1204 may receive the third wakeup signal (WUS_3) 1328.

At 1814, the UE transitions at least one of the first radio or the second radio to an awake mode based on information in the wakeup signal. For example, with reference to FIG. 10, the wakeup receiver circuit 1012 may be configured to provide the wakeup signal 1034 to the processing circuit 1010 via the data path 1024. The processing circuit 1010 may determine whether the wakeup indication in the wakeup signal 1034 is set to the first value, the second value, or the third value and may transition the first radio circuit 1006 and/or the second radio circuit 1008 to an awake mode based on the value of the wakeup indication.

For example, the processing circuit 1010 may transition the first radio circuit 1006 to the awake mode by transmitting a control signal to the first radio circuit 1006 via the data path 1018. For example, the processing circuit 1010 may transition the second radio circuit 1008 to the awake mode by transmitting a control signal to the second radio circuit 1008 via the data path 1020.

At 1816, the UE prioritizes one or more communications based on a set of priority rules when a first communication of the one or more communications associated with the first radio is overlapping with a second communication of the one or more communications associated with the second radio. For example, the first UE 1204 may prioritize one or more communications to and/or from the first UE 1204 based on a set of priority rules. For example, if the first UE 1204 is capable of using both its first and second radios for communication at the same time, the first UE 1204 may assign a priority to each transmission or reception associated with a certain radio (e.g., the first radio circuit 906, 1006 or the second radio circuit 908, 1008).

In one example, when a transmission or reception of a first signal using the first radio (e.g., the first radio circuit 906, 1006) of the first UE 1204 is overlapping with a transmission or reception of a second signal using the second radio (e.g., the second radio circuit 908, 1008) of the first UE 1204, the first UE 1204 may determine that one signal (e.g., the first signal 1340, 1346, 1350, 1354) has a higher priority than another signal (e.g., the second signal 1342, 1348, 1352, 1356). In some aspects, the first UE 1204 may use the determined priority to control one or more characteristics of the transmission or reception of the first signal and/or the transmission or reception of the second signal. For example, the first UE 1204 may apply a higher quality of service (QoS) to a transmission or reception of a signal determined to have higher priority than a signal determined to have lower priority.

At 1818, the UE controls a transmission power of one or more communications based on a set of transmission power control rules when a first communication of the one or more communications associated with the first radio is overlapping with a second communication of the one or more communications associated with the second radio. For example, if the first UE 1204 is capable of using both its first and second radios for communication at the same time (also referred to as overlapping communications), the first UE 1204 may apply a first transmission power for transmission of a first signal from the first radio and a second transmission power for transmission of a second signal from the second radio based on the set of transmission power control rules. In one example, the set of transmission power control rules may indicate that a transmission power for the second signal from the second radio is to be set below a threshold value if the first signal from the first radio includes control information (e.g., a transmission on PDCCH).

At 1820, the UE receives a request to transmit data, wherein the request indicates to transmit the data using the first radio, the second radio, or both the first radio and the second radio. For example, the message 1336 may include a request to transmit data. The request may indicate to transmit the data using the first radio, the second radio, or both the first radio and the second radio of the first UE 1204.

At 1822, the UE selects the first radio, the second radio, or both the first radio and the second radio for transmission of the data based on a transmission power associated with the data, a priority of the first radio, a priority of the second radio, and an available power of the apparatus. For example, the first UE 1204 may select the first radio, the second radio, or both the first radio and the second radio for transmission of the data based on a transmission power associated with the data, a priority of the first radio, a priority of the second radio, and an available power of the apparatus.

At 1824, the UE transmits the data based on the selection. For example, the first UE 1204 may transmit the data based on the selection (e.g., in the first signal 1340, 1346, 1350, 1354 and/or the second signal 1342, 1348, 1352, 1356).

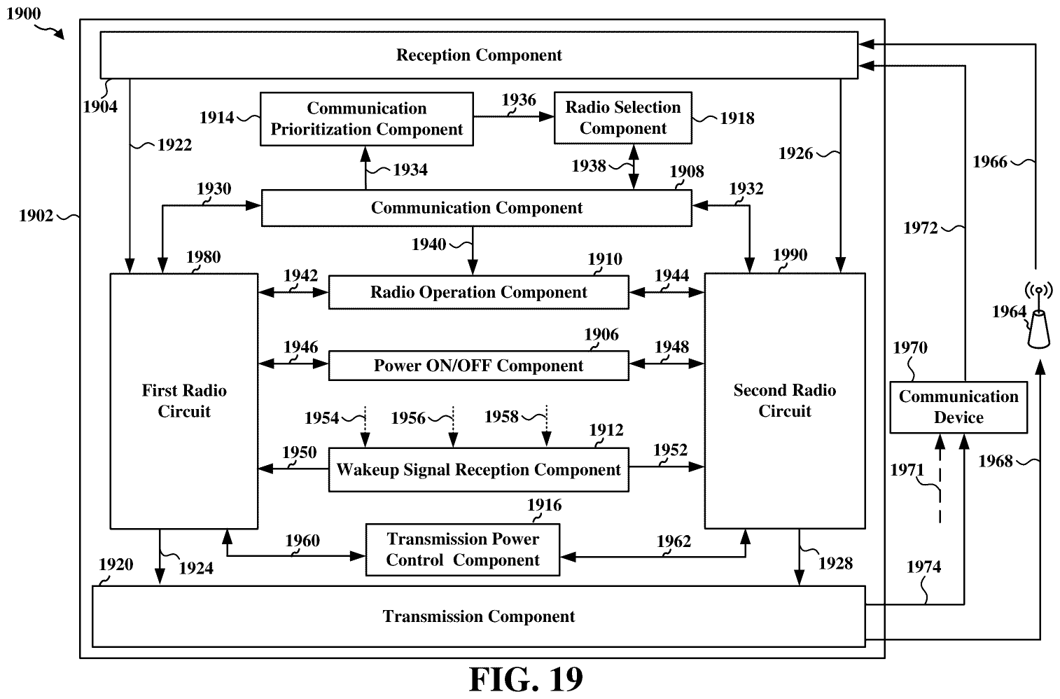

FIG. 19 is a conceptual data flow diagram 1900 illustrating the data flow between different means/components in an example apparatus 1902. The apparatus may be a UE.

The apparatus includes a reception component 1904 that receives communications 1966, 1972. In some examples, the communication 1966 may be a DL signal from the network node 1964 (e.g., a base station) and the communication 1972 may be a CW signal, a backscattered signal (e.g., in response to an incident CW signal 1971), a message, or other suitable type of communication from the communication device 1970 (e.g., a UE, a passive communication device (e.g., an RFID tag), a UE including a passive communication device).

The apparatus includes a power ON/OFF component 1906 that powers OFF a first radio circuit 1980 when a second radio circuit 1990 is to be used for one or more wireless communications, where the first radio circuit enables communication using resources associated with a mobile network and the second radio circuit enables communication with a passive communication device. The power ON/OFF component 1906 may power ON or OFF the first radio circuit 1980 via control signaling through a signal path 1946 and may power ON or OFF the second radio circuit 1990 via control signaling through a signal path 1948.

The apparatus includes a communication component 1908 that communicates using the first radio circuit 1980 (e.g., via the signal path 1930) and/or the second radio circuit 1990 (e.g., via the signal path 1932). In some aspects, the communication component 1908 communicates using the second radio circuit 1990 while the first radio circuit 1980 is powered OFF. The communication component may decode a signal (e.g., the communication 1972) to determine information included in the signal. The communication component 1908 may transmit a signal (e.g., the signal 1928 via the communication 1974) using the second radio circuit 1990 to the communication device 1970. A frequency of the signal may be one of a set of frequencies preconfigured at the apparatus for the second radio circuit 1990.

The communication component 1908 communicates using the first radio circuit 1980 (e.g., via the signal path 1930) a message using the resources associated with the mobile network, the message indicating at least one of a first preferred discontinuous reception mode configuration for the first radio of the apparatus or a second preferred discontinuous reception mode configuration for the second radio of the apparatus. The message may be included in the signal 1924 and the communication 1968 to the network node 1964.

The communication component 1908 receives, using the first radio circuit 1980, configuration information (e.g., via the communications 1966 and the signal 1922) indicating to use the first discontinuous reception mode configuration for the first radio and the second discontinuous reception mode configuration for the second radio.

The first radio circuit 1980 receives configuration information (e.g., via the communications 1966 and the signal 1922) associated with the second radio circuit 1990. The second radio circuit 1990 receives configuration information (e.g., via the communications 1972 and the signal 1926) associated with the second radio circuit 1990.

The apparatus includes a radio operation component 1910 that operates the first and second radio circuits 1980 and 1990 via the signal paths 1942, 1944. The apparatus operates the first radio circuit 1980 based on a first discontinuous reception mode configuration. The apparatus operates the second radio circuit 1990 based on a second discontinuous reception mode configuration.

The radio operation component 1910 may receive the first discontinuous reception mode configuration and/or a second discontinuous reception mode configuration via a signal 1940 from the communication component.

The apparatus includes a wakeup signal reception component 1912 that receives at least one of a first wakeup signal 1954 from a first wakeup signal receiver circuit associated with the first radio circuit 1980, a second wakeup signal 1956 from a second wakeup signal receiver circuit associated with the second radio circuit 1990, or a third wakeup signal 1958 from a single wakeup signal receiver circuit associated with both the first and second radio circuits 1980, 1990.

The wakeup signal reception component 1912 transitions (e.g., via a signal 1950) the first radio circuit 1980 to an awake mode if the first wakeup signal is received. The wakeup signal reception component 1912 transitions (e.g., via a signal 1952) the second radio circuit 1990 to an awake mode if the second wakeup signal is received. The wakeup signal reception component 1912 transitions (e.g., via the signal 1950 and/or the signal 1952) the first radio circuit 1980 and/or the second radio circuit 1990 to an awake mode based on information in the third wakeup signal 1958.

The apparatus includes a communication prioritization component 1914 that prioritizes one or more communications (e.g., one or more communications of the communication component 1908 received via a signal 1934) based on a set of priority rules when a first communication of the one or more communications associated with the first radio is overlapping with a second communication of the one or more communications associated with the second radio.

The apparatus includes a transmission power control component 1916 that controls a transmission power (e.g., via control signaling through respective signal paths 1960, 1962) of one or more communications based on a set of transmission power control rules when a first communication of the one or more communications associated with the first radio is overlapping with a second communication of the one or more communications associated with the second radio.

The apparatus includes a radio selection component 1918 that selects the first radio, the second radio, or both the first radio and the second radio for transmission of the data (e.g., via control signaling through the signal path 1938) based on a transmission power associated with the data, a priority of the first radio, a priority of the second radio, and an available power of the apparatus. The priority of the first radio and the priority of the second radio may be indicated in a signal 1936 from the communication prioritization component 1914.

The apparatus includes a transmission component 1920 that transmits communications to the communication device 1970 and the network node 1964. The communication 1968 may be a signal or message (e.g., including data, configuration information, etc.), or any other suitable type of communication as described herein to the network node 1964. The communication 1974 may be a signal (e.g., a CW signal, a modulated CW signal, a data signal, etc.), a message (e.g., including data, configuration information, etc.), or other suitable type of communication as described herein to the communication device 1970.

The apparatus may include additional components that perform each of the blocks of the algorithm in the aforementioned flowcharts of FIGS. 15, 16, 17A, 17B, 18A, 18B. As such, each block in the aforementioned flowcharts of FIGS. 15, 16, 17A, 17B, 18A, 18B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

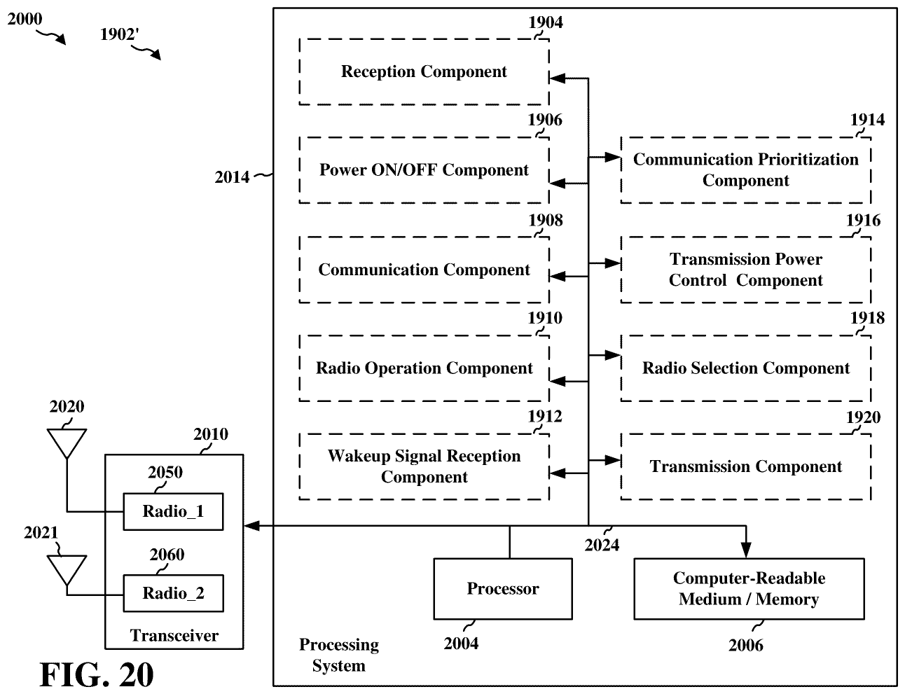

FIG. 20 is a diagram 2000 illustrating an example of a hardware implementation for an apparatus 1902′ employing a processing system 2014. The processing system 2014 may be implemented with a bus architecture, represented generally by the bus 2024. The bus 2024 may include any number of interconnecting buses and bridges depending on the specific application of the processing system 2014 and the overall design constraints. The bus 2024 links together various circuits including one or more processors and/or hardware components, represented by the processor 2004, the components 1904, 1906, 1908, 1910, 1912, 1914, 1916, 1918, 1920 and the computer-readable medium/memory 2006. The bus 2024 may also link various other circuits such as timing sources, peripherals, voltage regulators, and power management circuits, which are well known in the art, and therefore, will not be described any further.

The processing system 2014 may be coupled to a transceiver 2010. The transceiver 2010 may include multiple radios, such as a first radio circuit (Radio_1) 2050 and a second radio circuit (Radio_2) 2060. For example, the first radio circuit 2050 may the first radio circuit 906, 1006, 1406 described herein and the second radio circuit 2060 may the second radio circuit 908, 1008, 1408 described herein.

The transceiver 2010 is coupled to one or more antennas 2020, 2021. The transceiver 2010 provides a means for communicating with various other apparatus over a transmission medium. The transceiver 2010 receives a signal from the one or more antennas 2020, 2021 extracts information from the received signal, and provides the extracted information to the processing system 2014, specifically the reception component 1904. In addition, the transceiver 2010 receives information from the processing system 2014, specifically the transmission component 1920, and based on the received information, generates a signal to be applied to the one or more antennas 2020, 2021. The processing system 2014 includes a processor 2004 coupled to a computer-readable medium/memory 2006. The processor 2004 is responsible for general processing, including the execution of software stored on the computer-readable medium/memory 2006. The software, when executed by the processor 2004, causes the processing system 2014 to perform the various functions described supra for any particular apparatus. The computer-readable medium/memory 2006 may also be used for storing data that is manipulated by the processor 2004 when executing software. The processing system 2014 further includes at least one of the components 1904, 1906, 1908, 1910, 1912, 1914, 1916, 1918, 1920. The components may be software components running in the processor 2004, resident/stored in the computer readable medium/memory 2006, one or more hardware components coupled to the processor 2004, or some combination thereof. The processing system 2014 may be a component of the UE 350 and may include the memory 360 and/or at least one of the TX processor 368, the RX processor 356, and the controller/processor 359. Alternatively, the processing system 2014 may be the entire UE (e.g., see 350 of FIG. 3).

In one configuration, the apparatus 1902/1902′ for wireless communication includes means for powering OFF a first radio when a second radio is to be used for one or more wireless communications, wherein the first radio enables communication using resources associated with a mobile network and the second radio enables communication with a passive communication device, means for communicating using the second radio while the first radio is powered OFF, means for operating a first radio based on a first DRX mode configuration, wherein the first radio enables communication using resources associated with a mobile network, means for operating a second radio based on a second DRX mode configuration, wherein the second radio enables communication with a passive communication device, means for transmitting, using the first radio, a message using the resources associated with the mobile network, the message indicating at least one of a first preferred DRX mode configuration for the first radio of the apparatus or a second preferred DRX mode configuration for the second radio of the apparatus, means for receiving, using the first radio, configuration information indicating to use the first DRX mode configuration for the first radio and the second DRX mode configuration for the second radio, means for receiving at least one of a first wakeup signal from a first wakeup signal receiver associated with the first radio or a second wakeup signal from a second wakeup signal receiver associated with the second radio, means for transitioning the first radio to an awake mode if the first wakeup signal is received, means for transitioning the second radio to the awake mode if the second wakeup signal is received, means for receiving a wakeup signal from a wakeup signal receiver associated with the first radio and the second radio, means for transitioning at least one of the first radio or the second radio to an awake mode based on information in the wakeup signal, means for transmitting a first signal using the first radio and a second signal using the second radio, wherein at least a portion of the first signal is transmitted concurrently with at least a portion of the second signal, means for receiving a third signal using the first radio and a fourth signal using the second radio, wherein at least a portion of the third signal is received concurrently with a portion of the fourth signal, means for transmitting a first signal using the first radio, and means for receiving a second signal using the second radio, wherein at least a portion of the transmission of the first signal occurs concurrently with at least a portion of the reception of the second signal, means for receiving a first signal using the first radio, means for transmitting a second signal using the second radio, wherein at least a portion of the transmission of the second signal occurs concurrently with at least a portion of the reception of the first signal, means for prioritizing one or more communications based on a set of priority rules when a first communication of the one or more communications associated with the first radio is overlapping with a second communication of the one or more communications associated with the second radio, means for controlling a transmission power of one or more communications based on a set of transmission power control rules when a first communication of the one or more communications associated with the first radio is overlapping with a second communication of the one or more communications associated with the second radio, means for receiving a request to transmit data, wherein the request indicates to transmit the data using the first radio, the second radio, or both the first radio and the second radio, means for selecting the first radio, the second radio, or both the first radio and the second radio for transmission of the data based on a transmission power associated with the data, a priority of the first radio, a priority of the second radio, and an available power of the apparatus, and means for transmitting the data based on the selection.

The aforementioned means may be one or more of the aforementioned components of the apparatus 1902 and/or the processing system 2014 of the apparatus 1902′ configured to perform the functions recited by the aforementioned means. As described supra, the processing system 2014 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

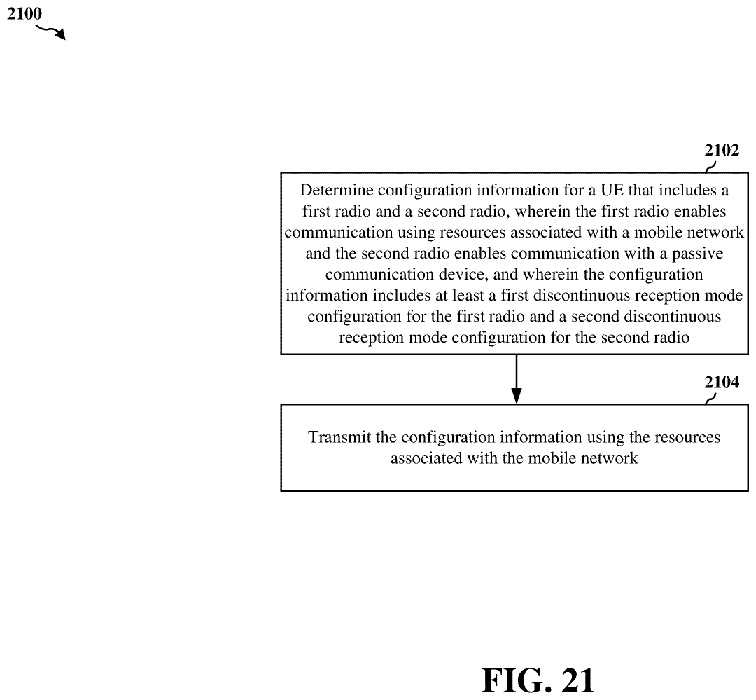

FIG. 21 is a flowchart 2100 of a method of wireless communication. The method may be performed by a network node (e.g., the base station 102, the network node 1202; the apparatus 2302/2302′; the processing system 2414, which may include the memory 376 and which may be the entire network node 1202 or a component of the network node 1202, such as the TX processor 316, the RX processor 370, and/or the controller/processor 375).

At 2102, the network node determines configuration information for a user equipment (UE) that includes a first radio and a second radio, wherein the first radio enables communication using resources associated with a mobile network and the second radio enables communication with a passive communication device, and wherein the configuration information includes at least a first DRX mode configuration for the first radio and a second DRX mode configuration for the second radio.

For example, the network node 1202 may determine the configuration information 1308 described with reference to FIG. 13A. The configuration information 1308 may include at least a first DRX mode configuration for the first radio (e.g., the first radio circuit 906, 1006) of the first UE 1204 and a second DRX mode configuration for the second radio (e.g., the second radio circuit 908, 1008) of the first UE 1204. In some examples, the configuration information 1308 may indicate a certain DRX mode configuration to be used for the first radio (e.g., the first radio circuit 906, 1006) of the first UE 1204 and/or the second radio (e.g., the second radio circuit 908, 1008) of the first UE 1204.

In some examples, the configuration information further includes at least one of a set of frequencies to be supported by the second radio (e.g., the second radio circuit 908, 1008) of the first UE 1204, one or more time-frequency allocations, a first set of configuration settings that enables a signal reception at the second radio, a second set of configuration settings that enables a signal transmission from the second radio, or control information.

At 2104, the network node transmits the configuration information using the resources associated with the mobile network. For example, with reference to FIG. 13A, the network node 1202 may use resources associated with the mobile network (e.g., a 5G NR network, LTE network, etc.) to transmit the configuration information 1308.

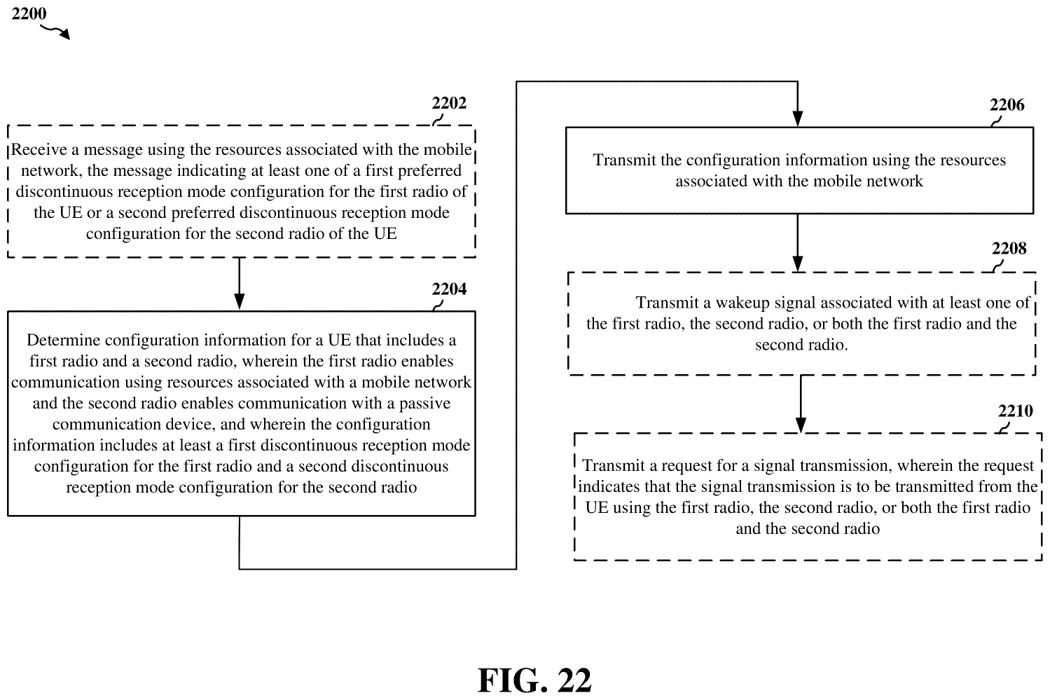

FIG. 22 is a flowchart 2200 of a method of wireless communication. The method may be performed by a network node (e.g., the base station 102, the network node 1202; the apparatus 2302/2302′; the processing system 2414, which may include the memory 376 and which may be the entire network node 1202 or a component of the network node 1202, such as the TX processor 316, the RX processor 370, and/or the controller/processor 375). It should be understood that blocks indicated with dashed lines in FIG. 22 represent optional blocks.

At 2202, the network node receives a message using the resources associated with the mobile network, the message indicating at least one of a first preferred DRX mode configuration for the first radio of the UE or a second preferred DRX mode configuration for the second radio of the UE.

For example, with reference to FIG. 13A, the network node 1202 may receive a first message 1304 using resources associated with the mobile network. The first message 1304 may indicate a first preferred DRX mode configuration for the first radio (e.g., the first radio circuit 906, 1006) of the first UE 1204 and/or a second preferred DRX mode configuration for the second radio (e.g., the second radio circuit 908, 1008) of the first UE 1204.

At 2204, the network node determines configuration information for a user equipment (UE) that includes a first radio and a second radio, wherein the first radio enables communication using resources associated with a mobile network and the second radio enables communication with a passive communication device, and wherein the configuration information includes at least a first DRX mode configuration for the first radio and a second DRX mode configuration for the second radio.

For example, the network node 1202 may determine the configuration information 1308 described with reference to FIG. 13A. The configuration information 1308 may include at least a first DRX mode configuration for the first radio (e.g., the first radio circuit 906, 1006) of the first UE 1204 and a second DRX mode configuration for the second radio (e.g., the second radio circuit 908, 1008) of the first UE 1204. In some examples, the configuration information 1308 may indicate a certain DRX mode configuration to be used for the first radio (e.g., the first radio circuit 906, 1006) of the first UE 1204 and/or the second radio (e.g., the second radio circuit 908, 1008) of the first UE 1204.

In some examples, the configuration information further includes at least one of a set of frequencies to be supported by the second radio (e.g., the second radio circuit 908, 1008) of the first UE 1204, one or more time-frequency allocations, a first set of configuration settings that enables a signal reception at the second radio, a second set of configuration settings that enables a signal transmission from the second radio, or control information.

At 2206, the network node transmits the configuration information using the resources associated with the mobile network. For example, with reference to FIG. 13A, the network node 1202 may use resources associated with the mobile network (e.g., a 5G NR network, LTE network, etc.) to transmit the configuration information 1308.

At 2208, the network node transmits a wakeup signal associated with at least one of the first radio, the second radio, or both the first radio and the second radio.

For example, with reference to FIG. 13A, the first network node 1202 may transmit a first wakeup signal 1318 for the first radio (e.g., the first radio circuit 906, 1006) of the first UE 1204 and/or a second wakeup signal 1320 for the second radio (e.g., the second radio circuit 908, 1008) of the first UE 1204. In some examples, the first wakeup signal 1318 and the second wakeup signal 1320 may respectively be the first wakeup signal 938 and the second wakeup signal 940 described with reference to FIG. 9.

For example, with reference to FIG. 13A, the first network node 1202 may transmit the third wakeup signal 1322 for the first and second radios (e.g., the first radio circuit 906, 1006 and the second radio circuit 908, 1008) of the first UE 1204.

At 2210, the network node transmits a request for a signal transmission, wherein the request indicates that the signal transmission is to be transmitted from the UE using the first radio, the second radio, or both the first radio and the second radio. For example, with reference to FIG. 13B, the network node 1202 may transmit the message 1336, which may include a request to transmit data. The request may indicate to transmit the data using the first radio (e.g., the first radio circuit 906, 1006), the second radio (e.g., the second radio circuit 908, 1008), or both the first radio and the second radio of the first UE 1204.

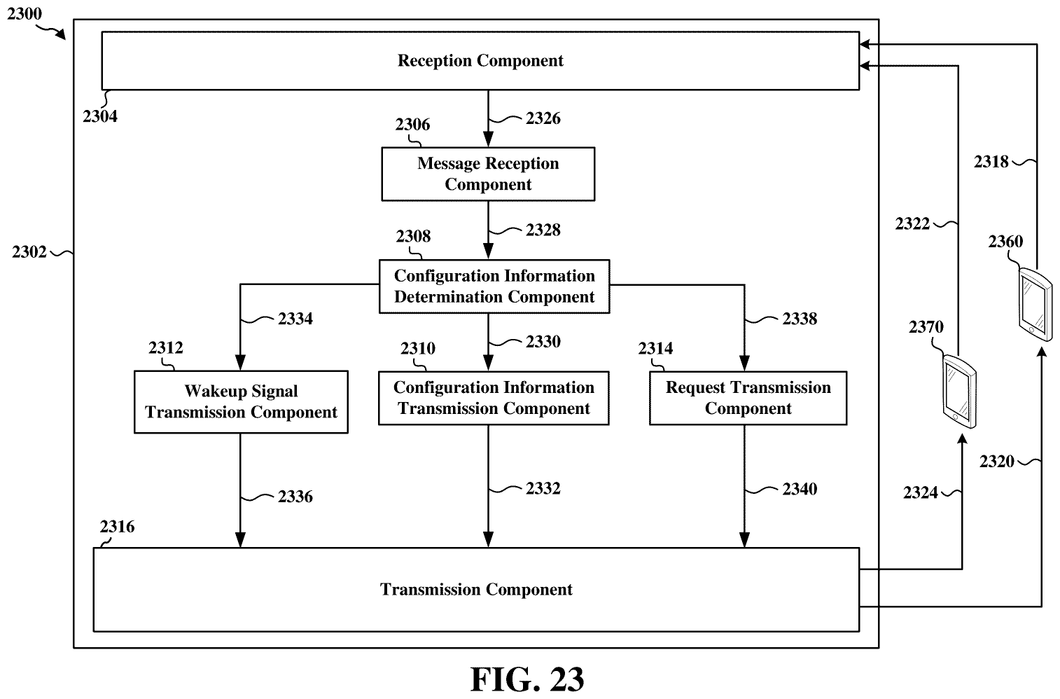

FIG. 23 is a conceptual data flow diagram 2300 illustrating the data flow between different means/components in an example apparatus 2302. The apparatus may be a network node (e.g., a base station).

The apparatus includes a reception component 2304 that receives communications from one or more UEs (e.g., communication 2318 from a first UE 2360 and a communication 2322 from a second UE 2370). The communications 2318, 2322 may be uplink signals.

The apparatus includes a message reception component 2306 that receives a message (e.g., via the communication 2318 and the signal 2326) using the resources associated with the mobile network. The message may indicate at least one of a first preferred discontinuous reception mode configuration for the first radio of a UE (e.g., the first UE 2360) or a second preferred discontinuous reception mode configuration for the second radio of the UE.

The apparatus includes a configuration information determination component 2308 that determine configuration information for a UE (e.g., the first UE 2360) that includes a first radio and a second radio, where the first radio enables communication using resources associated with a mobile network and the second radio enables communication with a passive communication device. The configuration information includes at least a first discontinuous reception mode configuration for the first radio and a second discontinuous reception mode configuration for the second radio. The configuration information determination component 2308 may receive the message indicating the first preferred discontinuous reception mode configuration for the first radio of the UE (e.g., the first UE 2360) or the second preferred discontinuous reception mode configuration for the second radio of the UE via the signal 2328.

The apparatus includes a configuration information transmission component 2310 that transmits the configuration information (e.g., the configuration information received from the configuration information determination component 2308 via the signal 2330) using the resources associated with the mobile network (e.g., via the signal 2332 and the communication 2320).

The apparatus includes a wakeup signal transmission component 2312 that transmits a wakeup signal (e.g., via the signal 2336 and the communication 2320) associated with at least one of the first radio, the second radio, or both the first radio and the second radio of the first UE 2360. The wakeup signal transmission component 2312 may receive configuration information for the first UE 2360 from the configuration information determination component 2308 and may transmit the wakeup signal (e.g., the signal 2336) based on the configuration information.

The apparatus includes a request transmission component 2314 that transmits (e.g., via the signal 2340 and the communication 2320) a request for a signal transmission. The request indicates that the signal transmission is to be transmitted from the UE (e.g., the first UE 2360) using the first radio, the second radio, or both the first radio and the second radio.

The apparatus includes a transmission component 2316 that transmits communications to one or more UEs (e.g., a communication 2320 to the first UE 2360 and a communication 2324 to the second UE 2370). The communications 2320, 2324 may be downlink signals.

The apparatus may include additional components that perform each of the blocks of the algorithm in the aforementioned flowcharts of FIGS. 21 and 22. As such, each block in the aforementioned flowcharts of FIGS. 21 and 22 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

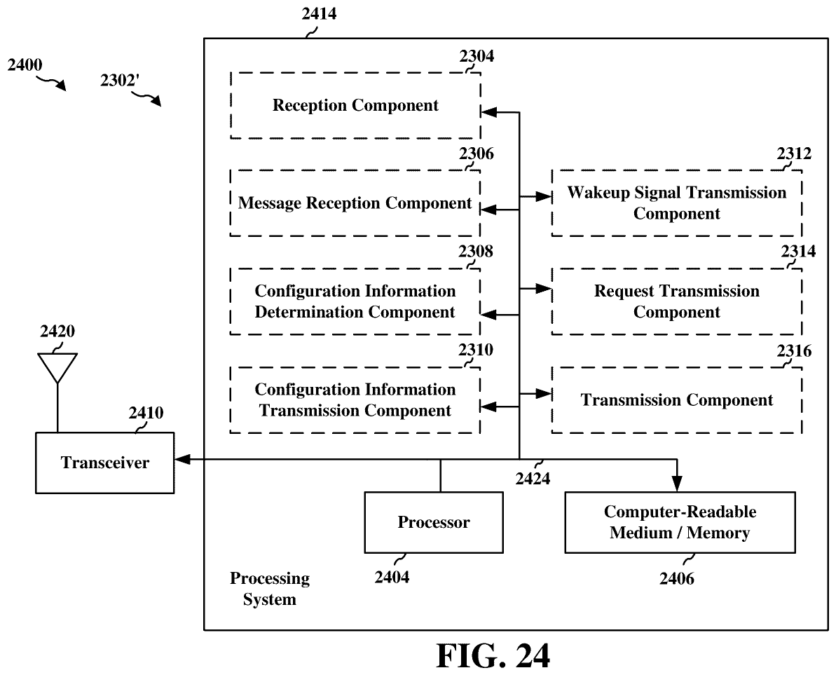

FIG. 24 is a diagram 2400 illustrating an example of a hardware implementation for an apparatus 2302′ employing a processing system 2414. The processing system 2414 may be implemented with a bus architecture, represented generally by the bus 2424. The bus 2424 may include any number of interconnecting buses and bridges depending on the specific application of the processing system 2414 and the overall design constraints. The bus 2424 links together various circuits including one or more processors and/or hardware components, represented by the processor 2404, the components 2304, 2306, 2308, 2310, 2312, 2314, 2316 and the computer-readable medium/memory 2406. The bus 2424 may also link various other circuits such as timing sources, peripherals, voltage regulators, and power management circuits, which are well known in the art, and therefore, will not be described any further.

The processing system 2414 may be coupled to a transceiver 2410. The transceiver 2410 is coupled to one or more antennas 2420. The transceiver 2410 provides a means for communicating with various other apparatus over a transmission medium. The transceiver 2410 receives a signal from the one or more antennas 2420, extracts information from the received signal, and provides the extracted information to the processing system 2414, specifically the reception component 2304. In addition, the transceiver 2410 receives information from the processing system 2414, specifically the transmission component 2316, and based on the received information, generates a signal to be applied to the one or more antennas 2420. The processing system 2414 includes a processor 2404 coupled to a computer-readable medium/memory 2406. The processor 2404 is responsible for general processing, including the execution of software stored on the computer-readable medium/memory 2406. The software, when executed by the processor 2404, causes the processing system 2414 to perform the various functions described supra for any particular apparatus. The computer-readable medium/memory 2406 may also be used for storing data that is manipulated by the processor 2404 when executing software. The processing system 2414 further includes at least one of the components 2304, 2306, 2308, 2310, 2312, 2314, 2316. The components may be software components running in the processor 2404, resident/stored in the computer readable medium/memory 2406, one or more hardware components coupled to the processor 2404, or some combination thereof. The processing system 2414 may be a component of the base station 310 and may include the memory 376 and/or at least one of the TX processor 316, the RX processor 370, and the controller/processor 375. Alternatively, the processing system 2414 may be the entire base station (e.g., see 310 of FIG. 3).

In one configuration, the apparatus 2302/2302′ for wireless communication includes means for determining configuration information for a UE that includes a first radio and a second radio, wherein the first radio enables communication using resources associated with a mobile network and the second radio enables communication with a passive communication device, and wherein the configuration information includes at least a first DRX mode configuration for the first radio and a second DRX mode configuration for the second radio, means for transmitting the configuration information using the resources associated with the mobile network, means for receiving a message using the resources associated with the mobile network, the message indicating at least one of a first preferred DRX mode configuration for the first radio of the UE or a second preferred DRX mode configuration for the second radio of the UE, means for transmitting a request for a signal transmission, wherein the request indicates that the signal transmission is to be transmitted from the UE using the first radio, the second radio, or both the first radio and the second radio, means for transmitting a wakeup signal associated with at least one of the first radio, the second radio, or both the first radio and the second radio.

The aforementioned means may be one or more of the aforementioned components of the apparatus 2302 and/or the processing system 2414 of the apparatus 2302′ configured to perform the functions recited by the aforementioned means. As described supra, the processing system 2414 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

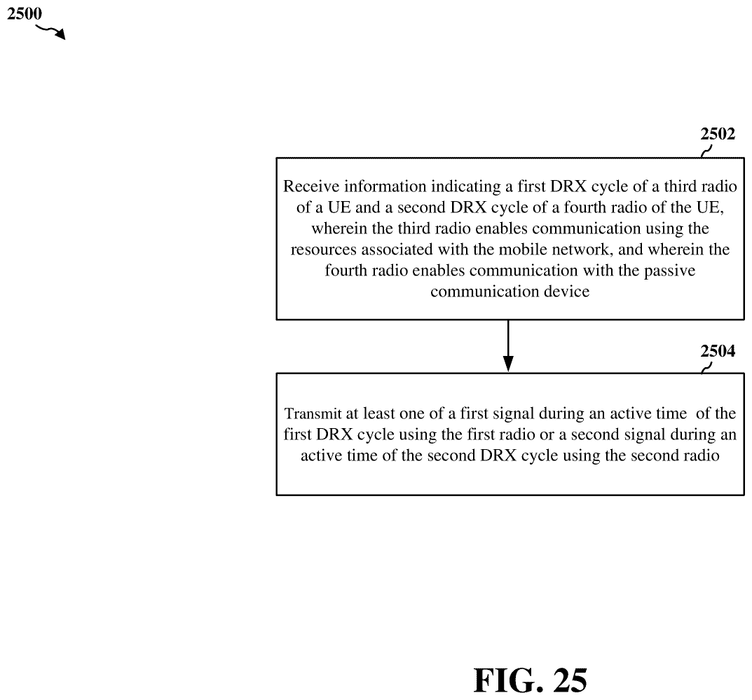

FIG. 25 is a flowchart 2500 of a method of wireless communication. The method may be performed by a UE (e.g., the UE 1208, 1440; the apparatus 2702/2702′; the processing system 2814, which may include the memory 360 and which may be the entire UE or a component of the UE, such as the TX processor 368, the RX processor 356, and/or the controller/processor 359).

At 2502, the UE receives information indicating a first DRX cycle of a third radio of a user equipment (UE) and a second DRX cycle of a fourth radio of the UE, wherein the third radio enables communication using the resources associated with the mobile network, and wherein the fourth radio enables communication with the passive communication device.

For example, with reference to FIG. 13A, the second UE 1208 may receive all or a portion of the configuration information 1308. Therefore, the second UE 1208 may receive information indicating a first DRX cycle of the first radio (e.g., the first radio circuit 906, 1006) of the first UE 1204 and a second DRX cycle of the second radio (e.g., the second radio circuit 908, 1008) of the first UE 1204.

At 2504, the UE transmits at least one of a first signal during an active time of the first DRX cycle using the first radio or a second signal during an active time of the second DRX cycle using the second radio. For example, with reference to FIG. 13B, the second UE 1208 may transmit the signal 1329 to the first UE 1204 during an active time of a DRX cycle of its first radio (e.g., the first radio circuit 906, 1006). For example, the signal 1329 may include data, configuration information, a command for the first UE 1204, or a request for the first UE 1204. For example, with reference to FIG. 13B, the second UE 1208 may transmit the CW signal 1330 using its second radio (e.g., the second radio circuit 1448).

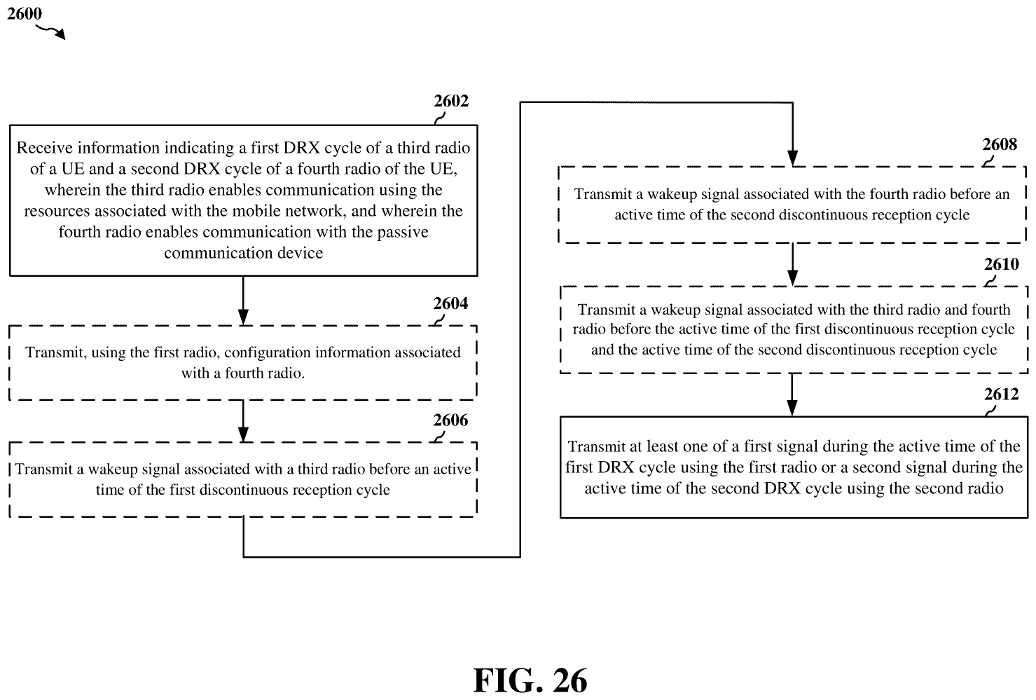

FIG. 26 is a flowchart 2600 of a method of wireless communication. The method may be performed by a UE (e.g., the UE 1208, 1440; the apparatus 2702/2702′; the processing system 2814, which may include the memory 360 and which may be the entire UE or a component of the UE, such as the TX processor 368, the RX processor 356, and/or the controller/processor 359). The UE may include a first radio that enables communication using resources associated with a mobile network and a second radio enables communication with a passive communication device. It should be understood that blocks indicated with dashed lines in FIG. 26 represent optional blocks.

At 2602, the UE (e.g., the second UE 1208) receives information indicating a first DRX cycle of a third radio of a UE (e.g., the first radio of the first UE 1204) and a second DRX cycle of a fourth radio of the UE (e.g., the second radio of the first UE 1204), wherein the third radio enables communication using the resources associated with the mobile network, and wherein the fourth radio enables communication with the passive communication device.

For example, with reference to FIG. 13A, the second UE 1208 may receive all or a portion of the configuration information 1308. Therefore, the second UE 1208 may receive information indicating a first DRX cycle of the first radio (e.g., the first radio circuit 906, 1006) of the first UE 1204 and a second DRX cycle of the second radio (e.g., the second radio circuit 908, 1008) of the first UE 1204.

At 2604, the UE transmits, using the first radio, configuration information associated with the fourth radio. For example, the second UE 1208 may transmit, using its first radio (e.g., the first radio circuit 1446), configuration information 1312 associated with the second radio (e.g., the second radio circuit 908, 1008) of the first UE 1204. For example, the configuration information 1312 may include a set of frequencies to be supported by the second radio (e.g., the second radio circuit 908, 1008) of the first UE 1204, one or more time-frequency allocations, and/or a set of configuration settings that enables a signal reception (e.g., from the second UE 1208) at the second radio (e.g., the second radio circuit 908, 1008) of the first UE 1204.

At 2606, the UE transmits a wakeup signal associated with the third radio before the active time of the first DRX cycle. For example, the second UE 1208 may transmit the first wakeup signal 1324.

At 2608, the UE transmits a wakeup signal associated with the fourth radio before the active time of the second DRX cycle. For example, the second UE 1208 may transmit the second wakeup signal 1326.

At 2610, the UE transmits a wakeup signal associated with the third radio and fourth radio before the active time of the first DRX cycle and the active time of the second DRX cycle. For example, the second UE 1208 may transmit the third wakeup signal 1328.

At 2612, the UE transmits at least one of a first signal during an active time of the first DRX cycle using the first radio or a second signal during an active time of the second DRX cycle using the second radio. For example, with reference to FIG. 13B, the second UE 1208 may transmit the signal 1329 to the first UE 1204 during an active time of a DRX cycle of its first radio (e.g., the first radio circuit 906, 1006). For example, the signal 1329 may include data, configuration information, a command for the first UE 1204, or a request for the first UE 1204. For example, with reference to FIG. 13B, the second UE 1208 may transmit the CW signal 1330 using its second radio (e.g., the second radio circuit 1448).

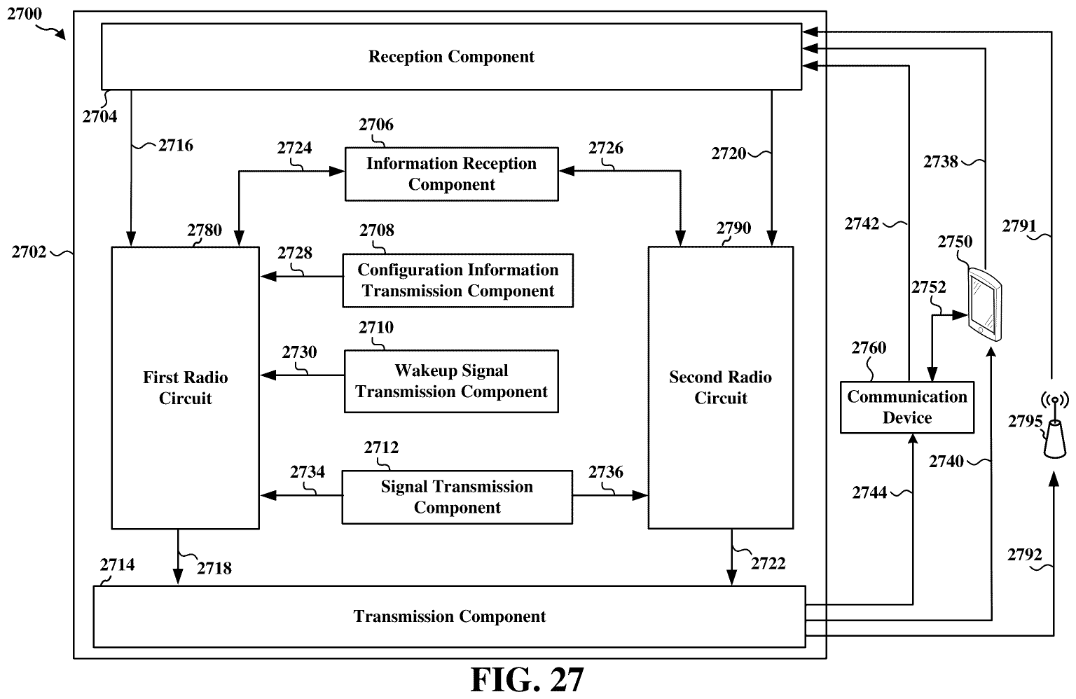

FIG. 27 is a conceptual data flow diagram 2700 illustrating the data flow between different means/components in an example apparatus 2702. The apparatus may be a UE. The apparatus includes a first radio circuit 2780 for communication using resources associated with a mobile network and a second radio circuit 2790 for communication with a communication device 2760.

The apparatus includes a reception component 2704 that receives communications 2378, 2742, 2791. In some examples, the communication 2738 from the UE 2750 may be a sidelink communication (e.g., over a PC5 link). In some examples, the communication 2742 from the communication device 2760 may be a CW signal, a backscattered signal (e.g., in response to an incident CW signal, such as the communication 2744), a message, or other suitable type of communication from the communication device 2760 (e.g., a UE, a passive communication device (e.g., an RFID tag), a UE including a passive communication device). In some examples, the communication 2791 from the network node 2795 may be a downlink signal.

The apparatus includes an information reception component 2706 that receives (e.g., via a communication 2738, 2791, a signal 2716, and a signal path 2724) information indicating a first DRX cycle of a third radio of a UE (e.g., the first UE 2750) and a second DRX cycle of a fourth radio of the UE, where the third radio enables communication using the resources associated with the mobile network, and wherein the fourth radio enables communication with the communication device 2760. The apparatus may receive a communication (e.g., the communication 2738) from the UE 2750 using the second radio circuit 2790 (e.g., via the signal 2720). For example, the signal 2720 may be provided to the information reception component 2706 via a signal path 2726.

The apparatus transmits at least one of a first signal (e.g., a signal 2718 via the communication 2740) during an active time of the first DRX cycle using the first radio or a second signal (e.g., a signal 2722 via the communication 2744) during an active time of the second DRX cycle using the second radio.

The apparatus includes a configuration information transmission component 2708 that transmits, using the first radio, configuration information (e.g., configuration information provided to the first radio circuit 2780 via a signal 2728) associated with the fourth radio. For example, the configuration information may be transmitted via the signal 2718 and the communication 2740.

The apparatus includes a wakeup signal transmission component 2710 that transmits a wakeup signal 2730 (e.g., via the signal 2718 and the communication 2740). The wakeup signal 2730 may be associated with the fourth radio before the active time of the second DRX cycle, associated with the third radio before the active time of the first DRX cycle, or associated with the third radio and fourth radio before the active time of the first DRX cycle and the active time of the second DRX cycle.

The apparatus includes a signal transmission component 2712 that transmits a signal 2734 (e.g., via the signal 2718 and the communication 2740) to the UE 2750 or transmits the signal 2734 (e.g., via the signal 2718 and the communication 2792) to the network node 2795. The signal 2734 may include a message. The signal transmission component 2712 further transmits a CW signal (e.g., via the signals 2736, 2722 and the communication 2744) to the communication device 2760. An RFID tag in the communication device 2760 may backscatter (e.g., through a signal path 2752) the CW signal in the communication 2744.

The apparatus includes a transmission component 2714 that transmits communications 2740, 2744, 2792. In some examples, the communication 2740 to the UE 2750 may be a sidelink communication (e.g., over a PC5 link). In some examples, the communication 2744 to the communication device 2760 may be a CW signal. In some examples, the communication 2792 to the network node 2795 may be an uplink signal.

The apparatus may include additional components that perform each of the blocks of the algorithm in the aforementioned flowcharts of FIGS. 25 and 26. As such, each block in the aforementioned flowcharts of FIGS. 25 and 26 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

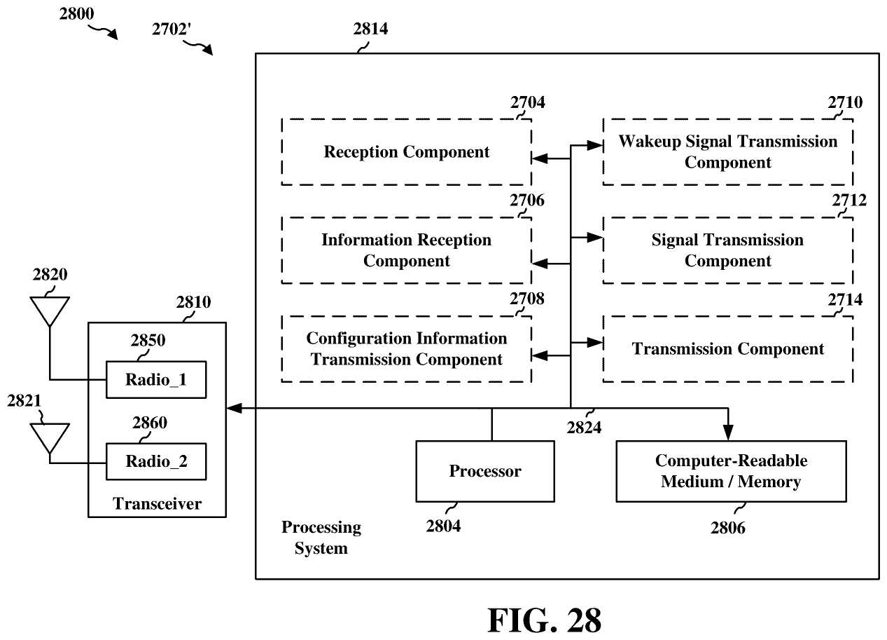

FIG. 28 is a diagram 2800 illustrating an example of a hardware implementation for an apparatus 2702′ employing a processing system 2814. The processing system 2814 may be implemented with a bus architecture, represented generally by the bus 2824. The bus 2824 may include any number of interconnecting buses and bridges depending on the specific application of the processing system 2814 and the overall design constraints. The bus 2824 links together various circuits including one or more processors and/or hardware components, represented by the processor 2804, the components 2704, 2706, 2708, 2710, 2712, 2714 and the computer-readable medium/memory 2806. The bus 2824 may also link various other circuits such as timing sources, peripherals, voltage regulators, and power management circuits, which are well known in the art, and therefore, will not be described any further.

The processing system 2814 may be coupled to a transceiver 2810. The transceiver 2810 may include multiple radios, such as a first radio circuit (Radio_1) 2850 and a second radio circuit (Radio_2) 2860. For example, the first radio circuit 2850 may the first radio circuit 1446 described herein and the second radio circuit 2860 may the second radio circuit 1448 described herein.

The transceiver 2810 is coupled to one or more antennas 2820, 2821. The transceiver 2810 provides a means for communicating with various other apparatus over a transmission medium. The transceiver 2810 receives a signal from the one or more antennas 2820, 2821, extracts information from the received signal, and provides the extracted information to the processing system 2814, specifically the reception component 2704. In addition, the transceiver 2810 receives information from the processing system 2814, specifically the transmission component 2714, and based on the received information, generates a signal to be applied to the one or more antennas 2820, 2821. The processing system 2814 includes a processor 2804 coupled to a computer-readable medium/memory 2806. The processor 2804 is responsible for general processing, including the execution of software stored on the computer-readable medium/memory 2806. The software, when executed by the processor 2804, causes the processing system 2814 to perform the various functions described supra for any particular apparatus. The computer-readable medium/memory 2806 may also be used for storing data that is manipulated by the processor 2804 when executing software. The processing system 2814 further includes at least one of the components 2704, 2706, 2708, 2710, 2712, 2714. The components may be software components running in the processor 2804, resident/stored in the computer readable medium/memory 2806, one or more hardware components coupled to the processor 2804, or some combination thereof. The processing system 2814 may be a component of the UE 350 and may include the memory 360 and/or at least one of the TX processor 368, the RX processor 356, and the controller/processor 359. Alternatively, the processing system 2814 may be the entire UE (e.g., see 350 of FIG. 3).

In one configuration, the apparatus 2702/2702′ for wireless communication includes means for receiving information indicating a first DRX cycle of a third radio of a UE and a second DRX cycle of a fourth radio of the UE, wherein the third radio enables communication using the resources associated with a mobile network, and wherein the fourth radio enables communication with a passive communication device, means for transmitting at least one of a first signal during an active time of the first DRX cycle using the first radio or a second signal during an active time of the second DRX cycle using the second radio, means for transmitting, using the first radio, configuration information associated with the fourth radio, means for transmitting a wakeup signal associated with the fourth radio before the active time of the second DRX cycle, means for transmitting a wakeup signal associated with the third radio before the active time of the first DRX cycle, means for transmitting a wakeup signal associated with the third radio and the fourth radio before the active time of the first DRX and the active time of the second DRX cycle.

The aforementioned means may be one or more of the aforementioned components of the apparatus 2702 and/or the processing system 2814 of the apparatus 2702′ configured to perform the functions recited by the aforementioned means. As described supra, the processing system 2814 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

The described aspects may improve the operation and performance of a UE implementing multiple radios. For example, communications with a passive communication device (e.g., an RFID tag) using the second radio (e.g., the second radio circuit 908, 1008) of the UE may involve significantly higher energy signals than communications with a mobile network (e.g., a network node, such as the network node 1202) using a first radio (e.g., the first radio circuit 906, 1006 for communication using resources associated with a mobile network) of the UE. Therefore, powering OFF the first radio (e.g., the first radio circuit 906, 1006) at the UE when communicating with the second radio (e.g., the second radio circuit 908, 1008) of the UE may prevent damage to the more sensitive RF front end components of the first radio.

As another example, the described aspects allow the multiple radios to operate based on the same or different DRX configurations of a DRX mode to achieve energy savings at the UE. Moreover, when the multiple radios are operating in a DRX mode, the described aspects allow the use of wakeup signals to transition some or all of the multiple radios to an awake mode.

The following provides an overview of aspects of the present disclosure:

Aspect 1: An apparatus for wireless communication, comprising: a memory; and at least one processor coupled to the memory and configured to: power OFF a first radio when a second radio is to be used for one or more wireless communications, wherein the first radio enables communication using resources associated with a mobile network and the second radio enables communication with a passive communication device; and communicate using the second radio while the first radio is powered OFF.

Aspect 2: The apparatus of aspect 1, wherein the passive communication device includes a radio frequency identification (RFID) tag, and wherein the at least one processor configured to communicate using the second radio while the first radio is powered OFF is further configured to: receive a signal using the second radio from the RFID tag, wherein a frequency of the signal is one of a set of frequencies preconfigured at the apparatus for the second radio; and decode the signal to determine information included in the signal.

Aspect 3: The apparatus of aspect 1 or 2, wherein the passive communication device is a radio frequency identification (RFID) tag, and wherein the at least one processor configured to communicate using the second radio while the first radio is powered OFF is further configured to: transmit a signal using the second radio to the RFID tag, wherein a frequency of the signal is one of a set of frequencies preconfigured at the apparatus for the second radio.

Aspect 4: The apparatus of any of aspects 1 through 3, wherein the signal includes information to be stored at the RFID tag.

Aspect 5: The apparatus of any of aspects 1 through 4, wherein the at least one processor is further configured to: receive, using the first radio, configuration information associated with the second radio.

Aspect 6: The apparatus of any of aspects 1 through 5, wherein the configuration information includes at least one of configuration information for a discontinuous reception mode for the second radio, a set of frequencies to be supported by the second radio, one or more time-frequency allocations, a first set of configuration settings that enables a signal reception at the second radio, a second set of configuration settings that enables a signal transmission from the second radio, or control information.

Aspect 7: The apparatus of any of aspects 1 through 6, wherein the at least one processor configured to communicate using the second radio while the first radio is powered OFF is further configured to: receive, using the second radio, configuration information associated with the second radio.

Aspect 8: The apparatus of any of aspects 1 through 7, wherein the configuration information includes at least a set of frequencies to be supported by the second radio.

Aspect 9: An apparatus for wireless communication, comprising: a memory; and at least one processor coupled to the memory and configured to: operate a first radio based on a first discontinuous reception mode configuration, wherein the first radio enables communication using resources associated with a mobile network; and operate a second radio based on a second discontinuous reception mode configuration, wherein the second radio enables communication with a passive communication device.

Aspect 10: The apparatus of aspect 9, wherein the at least one processor is further configured to: transmit, using the first radio, a message using the resources associated with the mobile network, the message indicating at least one of a first preferred discontinuous reception mode configuration for the first radio of the apparatus or a second preferred discontinuous reception mode configuration for the second radio of the apparatus; and receive, using the first radio, configuration information indicating to use the first discontinuous reception mode configuration for the first radio and the second discontinuous reception mode configuration for the second radio.

Aspect 11: The apparatus of aspect 9 or 10, wherein the first discontinuous reception mode configuration for the first radio is based on the first preferred discontinuous reception mode configuration, or wherein the second discontinuous reception mode configuration for the second radio is based on the second preferred discontinuous reception mode configuration.

Aspect 12: The apparatus of any of aspects 9 through 11, wherein the at least one processor is further configured to: receive at least one of a first wakeup signal from a first wakeup signal receiver associated with the first radio or a second wakeup signal from a second wakeup signal receiver associated with the second radio; transition the first radio to an awake mode if the first wakeup signal is received; and transition the second radio to the awake mode if the second wakeup signal is received.

Aspect 13: The apparatus of any of aspects 9 through 12, wherein the at least one processor is further configured to: receive a wakeup signal from a wakeup signal receiver associated with the first radio and the second radio; and transition at least one of the first radio or the second radio to an awake mode based on information in the wakeup signal.

Aspect 14: The apparatus of any of aspects 9 through 13, wherein a first discontinuous reception cycle based on the first discontinuous reception mode configuration is different from a second discontinuous reception cycle based on the second discontinuous reception mode configuration.

Aspect 15: The apparatus of any of aspects 9 through 14, wherein an active time of the first discontinuous reception cycle is nonoverlapping with an active time of the second discontinuous reception cycle.

Aspect 16: The apparatus of any of aspects 9 through 15, wherein a first discontinuous reception cycle based on the first discontinuous reception mode configuration is same as a second discontinuous reception cycle based on the second discontinuous reception mode configuration.

Aspect 17: The apparatus of any of aspects 9 through 16, wherein the at least one processor is further configured to: transmit a first signal using the first radio and a second signal using the second radio, wherein at least a portion of the first signal is transmitted concurrently with at least a portion of the second signal; or receive a third signal using the first radio and a fourth signal using the second radio, wherein at least a portion of the third signal is received concurrently with a portion of the fourth signal.

Aspect 18: The apparatus of any of aspects 9 through 17, wherein the at least one processor configured to: transmit a first signal using the first radio; and receive a second signal using the second radio, wherein at least a portion of the transmission of the first signal occurs concurrently with at least a portion of the reception of the second signal.

Aspect 19: The apparatus of any of aspects 9 through 18, wherein the at least one processor is further configured to: receive a first signal using the first radio; and transmit a second signal using the second radio, wherein at least a portion of the transmission of the second signal occurs concurrently with at least a portion of the reception of the first signal.

Aspect 20: The apparatus of any of aspects 9 through 19, wherein the at least one processor is further configured to: prioritize one or more communications based on a set of priority rules when a first communication of the one or more communications associated with the first radio is overlapping with a second communication of the one or more communications associated with the second radio.

Aspect 21: The apparatus of any of aspects 9 through 20, wherein the at least one processor is further configured to: control a transmission power of one or more communications based on a set of transmission power control rules when a first communication of the one or more communications associated with the first radio is overlapping with a second communication of the one or more communications associated with the second radio.

Aspect 22: The apparatus of any of aspects 9 through 21, wherein the at least one processor is further configured to: receive a request to transmit data, wherein the request indicates to transmit the data using the first radio, the second radio, or both the first radio and the second radio; select the first radio, the second radio, or both the first radio and the second radio for transmission of the data based on a transmission power associated with the data, a priority of the first radio, a priority of the second radio, and an available power of the apparatus; and transmit the data based on the selection.

Aspect 23: An apparatus for wireless communication, comprising: a memory; and at least one processor coupled to the memory and configured to: determine configuration information for a user equipment (UE) that includes a first radio and a second radio, wherein the first radio enables communication using resources associated with a mobile network and the second radio enables communication with a passive communication device, and wherein the configuration information includes at least a first discontinuous reception mode configuration for the first radio and a second discontinuous reception mode configuration for the second radio; and transmit the configuration information using the resources associated with the mobile network.

Aspect 24: The apparatus of aspect 23, wherein the configuration information further includes at least one of a set of frequencies to be supported by the second radio, one or more time-frequency allocations, a first set of configuration settings that enables a signal reception at the second radio, a second set of configuration settings that enables a signal transmission from the second radio, or control information.

Aspect 25: The apparatus of aspect 23 or 24, wherein the at least one processor is further configured to: receive a message using the resources associated with the mobile network, the message indicating at least one of a first preferred discontinuous reception mode configuration for the first radio of the UE or a second preferred discontinuous reception mode configuration for the second radio of the UE.

Aspect 26: The apparatus of any of aspects 23 through 25, wherein the first discontinuous reception mode configuration for the first radio is based on the first preferred discontinuous reception mode configuration, or wherein the second discontinuous reception mode configuration for the second radio is based on the second preferred discontinuous reception mode configuration.

Aspect 27: The apparatus of any of aspects 23 through 26, wherein a first discontinuous reception cycle based on the first discontinuous reception mode configuration for the first radio of the UE is different from a second discontinuous reception cycle based on the second discontinuous reception mode configuration for the second radio of the UE.

Aspect 28: The apparatus of any of aspects 23 through 27, wherein an active time of the first discontinuous reception cycle based on the first discontinuous reception mode configuration is nonoverlapping with an active time of the second discontinuous reception cycle based on the second discontinuous reception mode configuration.

Aspect 29: The apparatus of any of aspects 23 through 28, wherein a first discontinuous reception cycle based on the first discontinuous reception mode configuration is same as a second discontinuous reception cycle based on the second discontinuous reception mode configuration.

Aspect 30: The apparatus of any of aspects 23 through 29, wherein the at least one processor is further configured to: transmit a request for a signal transmission, wherein the request indicates that the signal transmission is to be transmitted from the UE using the first radio, the second radio, or both the first radio and the second radio.

Aspect 31: The apparatus of any of aspects 23 through 30, wherein the at least one processor is further configured to: transmit a wakeup signal associated with at least one of the first radio, the second radio, or both the first radio and the second radio.

Aspect 32: An apparatus for wireless communication, comprising: a first radio for communication using resources associated with a mobile network; a second radio for communication with a passive communication device; a memory; and at least one processor coupled to the memory and configured to: receive information indicating a first DRX cycle of a third radio of a user equipment (UE) and a second DRX cycle of a fourth radio of the UE, wherein the third radio enables communication using the resources associated with the mobile network, and wherein the fourth radio enables communication with the passive communication device; and transmit at least one of a first signal during an active time of the first DRX cycle using the first radio or a second signal during an active time of the second DRX cycle using the second radio.

Aspect 33: The apparatus of aspects 32, wherein the at least one processor is further configured to: transmit, using the first radio, configuration information associated with the fourth radio.

Aspect 34: The apparatus of aspect 32 or 33, wherein the configuration information includes at least one of a set of frequencies to be supported by the fourth radio, one or more time-frequency allocations, or a first set of configuration settings that enables a signal reception at the fourth radio.

Aspect 35: The apparatus of any of aspects 32 through 34, wherein the at least one processor is further configured to: transmit a wakeup signal associated with the fourth radio before the active time of the second DRX cycle.

Aspect 36: The apparatus of any of aspects 32 through 35, wherein the at least one processor is further configured to: transmit a wakeup signal associated with the third radio before the active time of the first DRX cycle.

Aspect 37: The apparatus of any of aspects 32 through 36, wherein the at least one processor is further configured to: transmit a wakeup signal associated with the third radio and fourth radio before the active time of the first DRX cycle and the active time of the second DRX cycle.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. It should be noted that the terms “data path” and “signal path” are used interchangeably herein. The terms Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
power OFF a first radio when a second radio is to be used for one or more wireless communications, wherein the first radio enables communication using resources associated with a mobile network and the second radio enables communication with a passive communication device; and
communicate using the second radio while the first radio is powered OFF.

2. The apparatus of claim 1, wherein the passive communication device includes a radio frequency identification (RFID) tag, and wherein the at least one processor configured to communicate using the second radio while the first radio is powered OFF is further configured to:
receive a signal using the second radio from the RFID tag, wherein a frequency of the signal is one of a set of frequencies preconfigured at the apparatus for the second radio; and
decode the signal to determine information included in the signal.

3. The apparatus of claim 1, wherein the passive communication device is a radio frequency identification (RFID) tag, and wherein the at least one processor configured to communicate using the second radio while the first radio is powered OFF is further configured to:
transmit a signal using the second radio to the RFID tag, wherein a frequency of the signal is one of a set of frequencies preconfigured at the apparatus for the second radio.

4. The apparatus of claim 3, wherein the signal includes information to be stored at the RFID tag.

5. The apparatus of claim 1, wherein the at least one processor is further configured to:
receive, using the first radio, configuration information associated with the second radio.

6. The apparatus of claim 5, wherein the configuration information includes at least one of configuration information for a discontinuous reception mode for the second radio, a set of frequencies to be supported by the second radio, one or more time-frequency allocations, a first set of configuration settings that enables a signal reception at the second radio, a second set of configuration settings that enables a signal transmission from the second radio, or control information.

7. The apparatus of claim 1, wherein the at least one processor configured to communicate using the second radio while the first radio is powered OFF is further configured to:
receive, using the second radio, configuration information associated with the second radio.

8. The apparatus of claim 7, wherein the configuration information includes at least a set of frequencies to be supported by the second radio.

9. An apparatus for wireless communication, comprising:
a memory; and
at least one processor coupled to the memory and configured to:
operate a first radio based on a first discontinuous reception mode configuration, wherein the first radio enables communication using resources associated with a mobile network; and
operate a second radio based on a second discontinuous reception mode configuration, wherein the second radio enables communication with a passive communication device.

10. The apparatus of claim 9, wherein the at least one processor is further configured to:
transmit, using the first radio, a message using the resources associated with the mobile network, the message indicating at least one of a first preferred discontinuous reception mode configuration for the first radio of the apparatus or a second preferred discontinuous reception mode configuration for the second radio of the apparatus; and
receive, using the first radio, configuration information indicating to use the first discontinuous reception mode configuration for the first radio and the second discontinuous reception mode configuration for the second radio.

11. The apparatus of claim 10, wherein the first discontinuous reception mode configuration for the first radio is based on the first preferred discontinuous reception mode configuration, or wherein the second discontinuous reception mode configuration for the second radio is based on the second preferred discontinuous reception mode configuration.

12. The apparatus of claim 9, wherein the at least one processor is further configured to:
receive at least one of a first wakeup signal from a first wakeup signal receiver associated with the first radio or a second wakeup signal from a second wakeup signal receiver associated with the second radio;
transition the first radio to an awake mode if the first wakeup signal is received; and
transition the second radio to the awake mode if the second wakeup signal is received.

13. The apparatus of claim 9, wherein the at least one processor is further configured to:
receive a wakeup signal from a wakeup signal receiver associated with the first radio and the second radio; and
transition at least one of the first radio or the second radio to an awake mode based on information in the wakeup signal.

14. The apparatus of claim 9, wherein a first discontinuous reception cycle based on the first discontinuous reception mode configuration is different from a second discontinuous reception cycle based on the second discontinuous reception mode configuration.

15. The apparatus of claim 14, wherein an active time of the first discontinuous reception cycle is nonoverlapping with an active time of the second discontinuous reception cycle.

16. The apparatus of claim 9, wherein a first discontinuous reception cycle based on the first discontinuous reception mode configuration is same as a second discontinuous reception cycle based on the second discontinuous reception mode configuration.

17. The apparatus of claim 9, wherein the at least one processor is further configured to:
transmit a first signal using the first radio and a second signal using the second radio, wherein at least a portion of the first signal is transmitted concurrently with at least a portion of the second signal; or
receive a third signal using the first radio and a fourth signal using the second radio, wherein at least a portion of the third signal is received concurrently with a portion of the fourth signal.

18. The apparatus of claim 9, wherein the at least one processor configured to:
transmit a first signal using the first radio; and
receive a second signal using the second radio, wherein at least a portion of the transmission of the first signal occurs concurrently with at least a portion of the reception of the second signal.

19. The apparatus of claim 9, wherein the at least one processor is further configured to:
receive a first signal using the first radio; and
transmit a second signal using the second radio, wherein at least a portion of the transmission of the second signal occurs concurrently with at least a portion of the reception of the first signal.

20. The apparatus of claim 9, wherein the at least one processor is further configured to:
prioritize one or more communications based on a set of priority rules when a first communication of the one or more communications associated with the first radio is overlapping with a second communication of the one or more communications associated with the second radio.

21. The apparatus of claim 9, wherein the at least one processor is further configured to:
control a transmission power of one or more communications based on a set of transmission power control rules when a first communication of the one or more communications associated with the first radio is overlapping with a second communication of the one or more communications associated with the second radio.

22. The apparatus of claim 9, wherein the at least one processor is further configured to:
receive a request to transmit data, wherein the request indicates to transmit the data using the first radio, the second radio, or both the first radio and the second radio;
select the first radio, the second radio, or both the first radio and the second radio for transmission of the data based on a transmission power associated with the data, a priority of the first radio, a priority of the second radio, and an available power of the apparatus; and
transmit the data based on the selection.

23. An apparatus for wireless communication, comprising:
a memory; and
at least one processor coupled to the memory and configured to:
determine configuration information for a user equipment (UE) that includes a first radio and a second radio, wherein the first radio enables communication using resources associated with a mobile network and the second radio enables communication with a passive communication device, and wherein the configuration information includes at least a first discontinuous reception mode configuration for the first radio and a second discontinuous reception mode configuration for the second radio; and
transmit the configuration information using the resources associated with the mobile network.

24. The apparatus of claim 23, wherein the configuration information further includes at least one of a set of frequencies to be supported by the second radio, one or more time-frequency allocations, a first set of configuration settings that enables a signal reception at the second radio, a second set of configuration settings that enables a signal transmission from the second radio, or control information.

25. The apparatus of claim 23, wherein the at least one processor is further configured to:
receive a message using the resources associated with the mobile network, the message indicating at least one of a first preferred discontinuous reception mode configuration for the first radio of the UE or a second preferred discontinuous reception mode configuration for the second radio of the UE.

26. The apparatus of claim 25, wherein the first discontinuous reception mode configuration for the first radio is based on the first preferred discontinuous reception mode configuration, or wherein the second discontinuous reception mode configuration for the second radio is based on the second preferred discontinuous reception mode configuration.

27. The apparatus of claim 23, wherein a first discontinuous reception cycle based on the first discontinuous reception mode configuration for the first radio of the UE is different from a second discontinuous reception cycle based on the second discontinuous reception mode configuration for the second radio of the UE.

28. The apparatus of claim 27, wherein an active time of the first discontinuous reception cycle based on the first discontinuous reception mode configuration is nonoverlapping with an active time of the second discontinuous reception cycle based on the second discontinuous reception mode configuration.

29. The apparatus of claim 23, wherein a first discontinuous reception cycle based on the first discontinuous reception mode configuration is same as a second discontinuous reception cycle based on the second discontinuous reception mode configuration.

30. The apparatus of claim 23, wherein the at least one processor is further configured to:
transmit a request for a signal transmission, wherein the request indicates that the signal transmission is to be transmitted from the UE using the first radio, the second radio, or both the first radio and the second radio.
